(19) United States
(12) Patent Application Publication
(10) Pub. No.: US 2026/0323424 A1
(43) Pub. Date: Oct. 15, 2026

(54) AI/ML ASSISTED HANDOVER

(71) Applicant: Fraunhofer-Gesellschaft zur Förderung der angewandten Forschung e.V., München (DE)

(72) Inventors: Tatiana RYKOV, Berlin (DE); Thomas FEHRENBACH, Berlin (DE); Baris GÖKTEPE, Berlin (DE); Thomas WIRTH, Berlin (DE); Thomas SCHIERL, Berlin (DE); Cornelius HELLGE, Berlin (DE); Thomas WIEGAND, Berlin (DE); Alvaro LÓPEZ RAVENTÓS, Berlin (DE); Buket TORUN, Berlin (DE)

(21) Appl. No.: 19/706,781

(22) Filed: Jun. 12, 2026

Related U.S. Application Data
(63) Continuation of application No. PCT/EP2024/085962, filed on Dec. 12, 2024.

(30) Foreign Application Priority Data
Dec. 14, 2023 (EP) 23216837.7

(51) Int. Cl. H04W 36/00; H04L 41/16

(52) U.S. Cl. CPC H04W 36/0072; H04L 41/16

(57) ABSTRACT

A user device, UE, for a wireless communication network, is provided. The UE is configured or preconfigured to be handed over from the source cell of the wireless communication network to a target cell of the wireless communication network. The UE uses at least one Artificial Intelligence/Machine Learning, AI/ML, handover, HO, model or at least one AI/ML HO functionality for performing one or more of the following: selecting from a set of target cells one or more target cells suitable for a handover, and/or determining a suitability of one or more target cells for a handover.

### CROSS-REFERENCES TO RELATED APPLICATIONS

This application is a continuation of co-pending International Application No. PCT/EP2024/085962, filed Dec. 12, 2024, which is incorporated herein by reference in its entirety, and additionally claims priority from European Patent Application No. 23216837.7, which was filed on Dec. 14, 2023, and is also incorporated herein in its entirety by reference.

### BACKGROUND OF THE INVENTION

The present invention relates to the field of wireless communication systems or networks, more specifically a use of at least one Artificial Intelligence/Machine Learning model, AI/ML, model or at least one AI/ML functionality for handling a handover, HO, in a wireless communication system or network. Embodiments of the present invention concern the use of an AI/ML HO model or functionalities at a user device, UE, or at a base station.

FIG. 1 is a schematic representation of an example of a terrestrial wireless network 100 including, as is shown in FIG. 1A, the core network, CN, 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. The BS may also comprise of integrated access and backhaul, IAB, nodes, e.g., an IAB Donor and/or IAB Node, consisting of a central unit, CU, as well as of a distributed unit, DU, and/or containing IAB-MTs including IAB mobile termination, MT. The term base station may refer to an access point, AP, in any of the WiFi standards, e.g., belonging to the IEEE 802.11-family. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANₙ may include more or less such cells, and RANₙ may also include only one base station. FIG. 1(B) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-family.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 6G or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or 5G-Advanced or NR, New Radio, or a possible future 6G radio system.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations or a WiFi AP.

In a wireless network or communication system Artificial Intelligence (AI) and Machine Learning (ML) may be employed for certain tasks. For example, according to 3GPP, AI/ML techniques and data analytics may be incorporated into the 5G system design for supporting certain tasks, e.g., for supporting network automation, data collection for various network functions, network energy savings, load balancing, mobility optimizations, AI/ML-based services, AI/ML for the new radio (NR) air interface. For example, when considering the NR air interface, AI/ML models may be employed for one or more of the following use cases:
Channel State Information (CSI):
For example, AI/ML may be used for a time-domain prediction.
Beam Management (BM):
For example, AI for beam management in 5G involves the use of AI and ML techniques to improve the efficiency and reliability of a wireless communication using directional beams. Beam management is the process of steering, tracking, and selecting the best beams for each user and link in a 5G network. This is challenging due to factors such as user mobility, a higher number of antennas, and the adoption of elevated frequencies. AI and ML may offer valuable solutions to mitigate this complexity and minimize the overhead associated with beam management and selection, while maintaining system performance.
Unlicensed band operation:
For example AI for channel access in unlicensed bands for 5G involves the use of AI and ML techniques to improve the efficiency and reliability of wireless communication using the unlicensed spectrum. The unlicensed spectrum is the part of the radio frequency spectrum that is not allocated to any specific service or operator, and may be used by anyone who follows certain rules and regulations. The unlicensed spectrum may offer more bandwidth, lower cost, and greater flexibility for 5G applications, especially in scenarios where the licensed spectrum is scarce or expensive. There are some challenges and opportunities of AI for channel access in unlicensed bands for 5G, like:
   Channel access methods: There are different methods for accessing unlicensed channels, such as listen before talk, LBT, gap-based channel access, contention-based random access, etc. Each method has its own advantages and disadvantages in terms of latency, throughput, fairness, and overhead. AI and ML may help to design, optimize, and adapt these methods according to the network conditions and user requirements.
   Spectrum sharing and coexistence: The unlicensed spectrum is shared by multiple users and technologies, such as Wi-Fi, Bluetooth, LTE-U, LAA, MulteFire, CBRS, NR-U, etc. This may cause interference, congestion, and collisions among different transmissions. AI and ML may help to enhance the spectrum sharing and coexistence mechanisms, such as sensing, coordination, scheduling, power control, beamforming, etc., to improve the spectral efficiency and quality of service.
   Private networks and industrial IoT: The unlicensed spectrum may enable the deployment of 5G private networks and industrial IoT applications, such as smart factories, warehouses, mines, etc. These applications have high demands for reliability, security, and low latency. AI and ML may help to customize and optimize the network performance for these applications, such as intelligent load balancing, proactive network slicing, anomaly detection, etc.
Positioning:
For example, a direct AI/ML positioning approach, e.g., fingerprinting, and an AI/ML assisted positioning approach, e.g., the output of the AI/ML model inference is an additional measurement and/or an enhancement of an existing measurement, may be implemented.

The AI/ML model may be running at one of the two sides or at both sides of the communication link, e.g., at the gNB or the network-side, e.g., CN, and/or at the UE. Some AI/ML models may not be specified and left up to implementation, while others, e.g., enabling AI/ML for the air interface, need to be specified.

It is noted that the information in the above section is only for enhancing the understanding of the background of the invention and, therefore, it may contain information that is not conventional technology that is already known to a person of ordinary skill in the art.

Starting from the above, there may be a need for improvements or enhancements to the use of AI/ML models for handling a handover, HO, in a wireless communication system or network.

### SUMMARY

An embodiment may have a user device, UE, for a wireless communication network, wherein the UE is configured or preconfigured to be handed over from the source cell of the wireless communication network to a target cell of the wireless communication network, and wherein the UE is to use at least one Artificial Intelligence/Machine Learning, AI/ML, handover, HO, model or at least one AI/ML HO functionality for performing one or more of the following: selecting from a set of target cells one or more target cells suitable for a handover, determining a suitability of one or more target cells for a handover.

Another embodiment may have a base station, BS, for a wireless communication network, wherein the BS is a source base station of a source cell and serves a user device, UE, of the wireless communication network, located in the source cell, UE being configured or preconfigured to be handed over from the source cell to a target cell of the wireless communication network, and wherein the BS is to use at least one Artificial Intelligence/Machine Learning model, AI/ML, handover, HO, model or at least one AI/ML HO functionality for performing one or more of the following: selecting one or more target cells suitable for a handover of the UE, determining a suitability of one or more target cells for a handover of the UE.

Another embodiment may have a wireless communication network, like a 3^{rd} Generation Partnership Project, 3GPP, system, having one or more user devices, UEs, according to the invention as mentioned above and/or one or more base stations, BSs, according to the invention as mentioned above.

According to another embodiment, a method for operating a user device, UE, for a wireless communication network, wherein the UE is configured or preconfigured to be handed over from the source cell of the wireless communication network to a target cell of the wireless communication network, may have the step of: using, by the UE, at least one Artificial Intelligence/Machine Learning, AI/ML, handover, HO, model or at least one AI/ML HO functionality for performing one or more of the following: selecting from a set of target cells one or more target cells suitable for a handover, determining a suitability of one or more target cells for a handover.

According to another embodiment, a method for operating a user device, UE, for a wireless communication network, wherein the BS is a source base station of a source cell and serves a user device, UE, of the wireless communication network, located in the source cell, UE being configured or preconfigured to be handed over from the source cell to a target cell of the wireless communication network, may have the step of: using, by the BS, at least one Artificial Intelligence/Machine Learning model, AI/ML, handover, HO, model or at least one AI/ML HO functionality for performing one or more of the following: selecting one or more target cells suitable for a handover of the UE, determining a suitability of one or more target cells for a handover of the UE.

Another embodiment may have a non-transitory digital storage medium having a computer program stored thereon to perform any of the inventive methods when said computer program is run by a computer.

### BRIEF DESCRIPTION OF THE DRAWINGS

Embodiments of the present invention will be detailed subsequently referring to the ap-pended drawings, in which:

FIG. 1A-B illustrate a wireless communication network, wherein FIG. 1A is a schematic representation of an example of a terrestrial wireless network, and FIG. 1B is a schematic representation of an example of a radio access network, RAN;

FIG. 2 illustrates an example of a conventional basic handover, HO, which is triggered as a user device, UE, moves from a current or source cell into a neighboring or target cell;

FIG. 3 illustrates a high level overview of a 5G/NR radio access network architecture used for implementing a conventional LTM-HO;

FIG. 4 is a schematic representation of a wireless communication system including a transmitter, like a base station, and one or more receivers, like user devices, UEs, implementing embodiments of the present invention;

FIG. 5 illustrates a user device, UE, and a base station in accordance with embodiments of the present invention;

FIG. 6 illustrates an embodiment of an information element, IE, for setting conditions for triggering a conditional handover including AI events;

FIG. 7 illustrates an embodiment of an information element, IE, defining a measurement report provided by a UE to a base station; and

FIG. 8 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

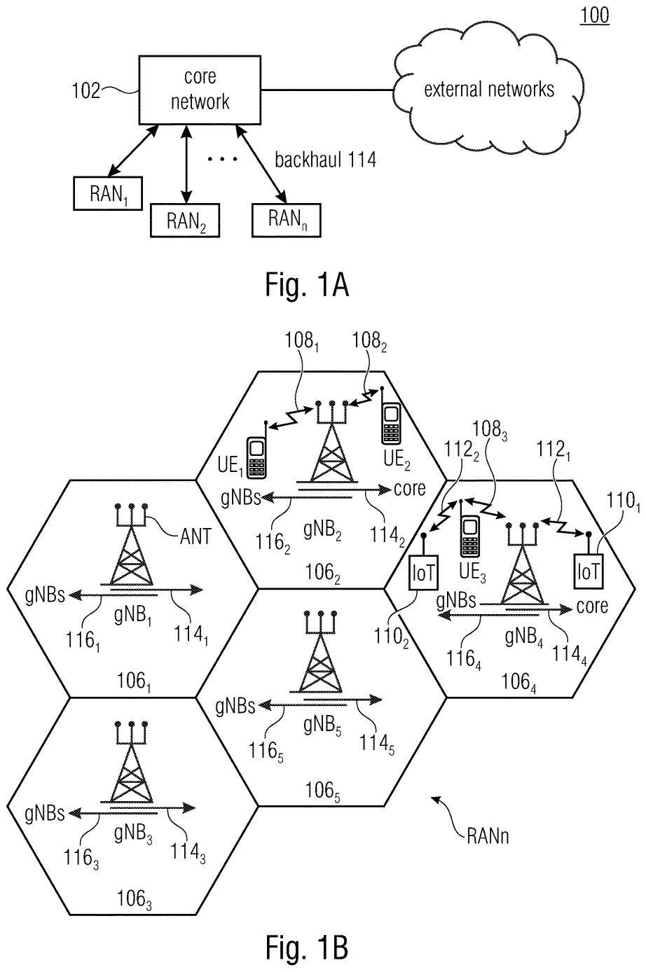

As wireless communication networks or systems, like the one described above with reference to FIG. 1, evolve, there is a trend to use higher frequencies and/or provide a denser deployment of subscribers or users. This may increase the amount of traffic created by the subscribers which, in turn, may make it more difficult to meet one or more desired quality of service, QoS, parameters, especially for subscribers or users having a high mobility and undergoing multiple handover, HO, processes. The HO processes may be improved by using AI/ML, for example for exploring an environment of the subscriber or user and processing the massive data sets available for optimizing the wireless communication network.

While existing handover mechanisms may perform well in a normal or regular mobility scenario, their performance may deteriorate in some scenarios, for example when subscribers or user devices, UEs, operate in higher frequency bands, like FR2 or FR3, or experience a high mobility, e.g., due to moving at a high speed or. In such scenarios, the existing handover mechanism may not achieve a desired performance. This may be due to the existing handover mechanisms being reactive by design. Reactive handovers are triggered by events such as a sudden drop in signal quality or strength. By the time these events are detected and the handover process is initiated, there might be a delay in transitioning to a new cell or beam. This delay may cause temporary service disruptions or quality degradation during the handover period. In some cases, reactive handovers may lead to a “ping-pong” effect, where the UE switches between cells or beams rapidly due to fluctuations in signal strength. This frequent handover may degrade overall performance and user experience. Moreover, reactive handover processes may demand more power from the UE, affecting battery life. Also in conventional handover processes, decisions may be made based on historical measurements and sometimes inaccurate radio resource measurements, RRM, or an inaccurate UE location so that reliable handover decisions may not be made. Also, the complexity, measurement effort and signaling overhead for carrying out a handover process may be high thereby leading to a degradation of network performance and user experience. Wireless networks operate in dynamic environments where conditions may change rapidly. The need to constantly measure and evaluate these changing conditions adds measurement effort and complexity to the handover process. This increased signaling overhead due to, e.g., frequent handovers that are triggered reactively includes the exchange of control messages between the UE and the network, which consumes network resources and may lead to inefficiencies, especially in dense or highly mobile network areas. Furthermore, further evolving wireless communication networks come with new services, for example a so-called extended reality, XR, service, that may require an even more reliable mobility connection as it is current achievable and, therefore, also a more reliable handover mechanism.

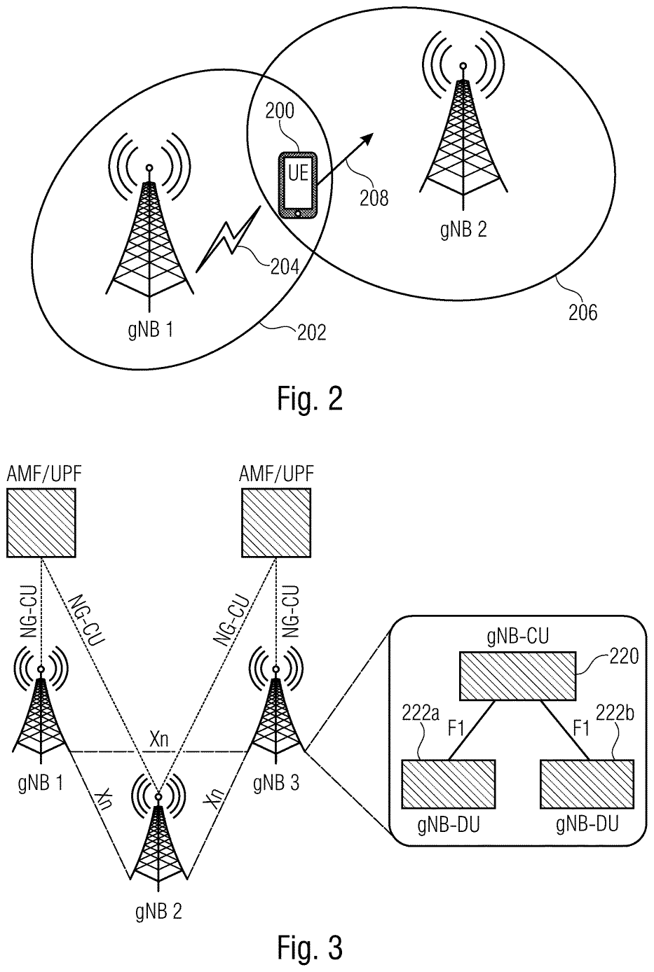

The existing handover mechanisms comprise a basic handover, HO, mechanism, a conditional handover, CHO, mechanism, and a Layer 1/Layer 2 Triggered Mobility, LTM, the LTM, handover, HO, mechanism. FIG. 2 illustrates an example of the basic handover, HO, which is triggered as a user device, UE, moves from a current or source cell into a neighboring or target cell. The UE 200 is within the coverage of the base station gNB1, i.e., is within a source cell 202 and is served by the base station gNB1, for example over the Uu interface 204. FIG. 2 also illustrates the target or neighboring cell 206 including a further base station gNB2. As is illustrated by the arrow 208, the UE 200 is assumed to be moving from the source cell 202 into the target or neighboring cell 206. The basic handover, HO, is mainly based on the long-term evolution, LTE, handover mechanism in which the network side controls the mobility of the UE 200 based on measurement reports from the UE 202. As the UE 200 moves into the coverage of the neighboring cell 206, the measurement parameters, for example, a reference signal received power, RSRP, or a reference signal received quality, RSRQ, of the neighboring cell 206 exceed the corresponding parameters measured for the current or source cell 202 so that a HO may be triggered. FIG. 2 illustrates the basic HO process of the UE 200 moving from the source or current cell 202 to the target or neighboring cell 206. The source base station gNB1 triggers a HO by sending a handover request to the target base station gNB2. After receiving an acknowledgement from the target base station gNB2, the source base station gNB1 initiates the handover by sending the UE 200 a handover command including the target cell configurations. The UE 200 synchronizes with the target cell 206 after the radio resource control, RRC, reconfigurations are applied with the target cell configurations.

The conditional handover, CHO, aims at improving the reliability and reducing the communication interruption time during a handover by means of decoupling the preparation and execution phases. In a CHO, a number of handover failures is reduced by preparing one or more target base stations or gNBs in advance and allowing the UE to decide when to make a handover. The main difference between the CHO and the basic HO is that the handover may be executed only if one or more associated conditions are met, whereas the basic HO is performed as soon as the handover command has been received from the source base station. For a conditional handover, the UE may be configured with up to two execution conditions per each candidate target cell, both of which need to be fulfilled before the handover execution may be initiated. For example, both conditions may apply to the same reference signal, RS, however, also different measurement quantities may be used for the evaluation, for example a measurement of the RSRP, the RSRQ or a Signal to Interference and Noise Ratio, SINR. The conditional handover process has the following main steps:
(1) A UE sends to a source base station or gNB a measurement report including the results for candidate target cells.
(2) During a preparation phase, the source base station may ask one or more of the target base stations or gNBs, for example up to eight candidate target cells, to acknowledge a handover request and prepare corresponding configurations to be used by the UE for accessing the respective target cell.
(3) The source base station sends to the UE a CHO command including the RRC reconfigurations and execution conditions for the respective target cells that have been acknowledged during the preparation phase.
(4) Upon receiving the CHO command, the UE checks the execution command and continues exchanging the data with the source base station until the condition is met, which is a main difference to the basic HO process where the UE receives the HO command and detaches immediately from the source base station to be attached to the target base station.
(5) Once the execution condition for any configured and prepared target cell is fulfilled, during the so-called execution phase, the UE initiates the CHO execution by sending a random access, RA, preamble to a target base station and waits for the response from the target base station for completing the handover process.

FIG. 3 illustrates a high level overview of a 5G/NR radio access network architecture used for implementing a LTM-HO. The architecture of FIG. 3 illustrates three base stations, gNB1 to gNB3 connected via the NG-CU interface with respective core network, CN, functions, like the Access and Mobility Management Function, AMF, and the User Plane Function, UPF. The respective base stations gNB1 to gNB3 are connected with each other over a backhaul interface, like the Xn interface. One or more of the base stations may be divided into at least two physical entities, e.g., a centralized unit, CU, and one or more distributed units, DUs. FIG. 3 illustrates that gNB3 includes a CU 220 and two DUs 222a, 222b each being linked with the CU over the F1 interface. The CU provides support for the higher layers of the protocol stack such as the Service Data Adaptation Protocol, SDAP, layer, the Packet Data Convergence Protocol, PDCP, layer and the Radio Resource Control, RRC, layer. The respective DUs provide support for the lower layers of the protocol stack, such as the Radio Link Control, RLC, layer, the Media Access Control, MAC, layer and the physical, PHY, layer. There may be a single CU for each base station or gNB controlling multiple DUs, and a DU is provided for supporting one or more cells so one gNB may control several cells. In the above-described basic HO and CHO processes, a handover is triggered by layer 3, L3, measurements and is done by RRC signaling. These types of HOs further require a reconfiguration of the upper layers, for example of the RRC and PDCP layers and/or a resetting of the lower layers, for example the MAC and/or PHY layers. This reconfiguration/resetting leads to an increase in latency, to a signaling overhead and to an extended interruption time. For addressing these issues, the LTM-HO has been introduced to enable a serving cell change via L1/L2 signaling while keeping a configuration of the upper layers and/or minimizing changes in the configuration of the lower layers, thereby reducing a latency, an overhead and an interruption time experienced during a handover process. The LTM-HO may be implemented in a 5G/NR RAN architecture as illustrated in FIG. 3, i.e., LTM supports the CU-DU split architecture, where the gNB-CU 220 may manage the higher layer protocols, like the PDCP and RRC layers, and the gNB-DUs 222a, 222b may control the lower layers, for example the PHY, MAC and RLC layers. The overall procedure of a LTM-HO may be as follows:
(1) The UE sends to the source gNB an L3 measurement report comprising the results for candidate target cells. Responsive to the report, the source gNB initiates the so-called LTM candidate preparation.
(2) The source gNB transmits an RRC reconfiguration message to the UE including the measurement configuration of one or more LTM candidate target cells for reporting L1 beam measurements and configurations for the HO.
(3) The UE stores the configurations of the LTM candidate target cells and transmits a RRC reconfiguration complete message to the source gNB.
(4) The UE may perform a synchronization and timing advance, TA, acquisition with the candidate target cells before receiving an LTM cell switch command.
(5) The UE performs L1 measurements on the configured LTM candidate target cells and transmits the L1 measurement reports of the serving and non-serving but prepared cell beams to the source gNB.
(6) During the LTM execution phase, the gNB decides to execute a LTM cell switch to a target cell and transmits a MAC control element, MAC-CE, which triggers the LTM cell switch. The UE switches to the configuration of the LTM candidate target cell decided by the gNB.
(7) The UE performs a random access procedure towards the target cell, in case a TA is not available.
(8) The UE indicates a successful completion of the LTM cell switch towards the target cell.

Although, the LTM-HO is capable to achieve some improvements over the basic HO and the CHO, still the performance may not be sufficient, for example in the scenarios mentioned above, like when operating in a higher frequency band, like FR 2 or FR3, or when handling a high mobility UE. For addressing the mentioned short comings, AI/ML models/functionalities may be implemented for potential mobility enhancements, for example for improving the HO performance by avoiding too early HOs and ping-pong HOs, for tuning HO parameters, for reducing a measurement effort, for reducing communication interruption and for reducing signaling overhead. While the above-mentioned conventional AI/ML approach may allow further improving the handover scenarios, like the ones described above with reference to FIGS. 2 and 3, the use of AI/ML may support, for example in case of a classic handover, the measurement procedures carried out at the UE triggering, eventually, a handover request. In the case of conditional handover, the use of AI/ML may support the measurement process and the reporting process at the UE side as well as the processing at the base station side for determining the conditions for the handover, for example. Also for a LTM-HO, AI/ML may support the measurement procedure. Thus, in conventional approaches, AI/ML is used only for improving respective actions or operations carried out with regard to the above-referenced conventional handover processes (basic HO, CHO, LTM-HO) like the handling of a large amount of measurement data and the like. While this may address some of the above-mentioned short comings, an actual decision about a target cell to which a UE is to be handed over, is still made on the basis of the now AI/ML processed measurement information.

However, there may be situations in which several target cells are available or in which not all of the available target cells are equally suitable for the handover process. Thus, despite the AI/ML support for the processing of the data obtained for deciding whether an HO is to be performed or not, the actual target cell to which the UE is to be switched to or handed over to may be decided in such a way that a non-optimum target cell is selected thereby jeopardizing the desired reliability of a mobile connection. Moreover, in case of conditional handover, the application of the conventional AI/ML, e.g., to the measurement process of each of the potential target cells provided by the network may be complex and require substantial computational resources. And even after the processing at the base station side for determining the AI/ML-based conditions for the CHO handover, according to the state-of-the-art handover process, as soon as one target cell fulfills the given conditions, the UE is to be handed over to it. However, this may lead to an inaccurate decision making, since the suitability for a handover operation of other target cells e.g. based on AI/ML output that fulfill or will fulfill the conditions in the nearest future is unknown. In other words, state-of-the-art AI/ML HOs may lead to catastrophic performance due to an unexpected behavior of the AI/ML algorithm. Introducing minimum conditions allows the network to make sure that the decision of the AI/ML HO prediction does not result in a significant performance degradation leading to a handover failure, HOF, or radio link failure, RLF.

Additionally, the suboptimal performance of conventional AI models may be tied to the fact that some scenarios are not fully reflective of the training conditions and/or configurations.

Embodiments of the present invention address the above problems by providing an approach in accordance with which a UE and/or a source base station use AI/ML for selecting a suitable target cell for the handover. More specifically, according to embodiments a user device, UE, may use AI/ML for selecting from a set of target cells one or more suitable target cells for the HO or for determining a suitability of one or more target cells for performing a handover of the UE from the source cell. In accordance with other embodiments, a base station is provided using AI/ML for selecting one or more target cells suitable for a handover of a UE currently served by the base station. The inventive approach, when compared to conventional approaches already using AI/ML for the handover process, is advantageous because, e.g., in case of a conditional handover, the network may provide minimum conditions to a UE, and accordingly AI/ML is applied only to those target cells that satisfy the given conditions, which may reduce computational resources in terms of AI/ML processing. Moreover, computing the suitability of the target cells that fulfilled the conditions might provide a more accurate way of handover decision-making.

Furthermore, a base station according to embodiments of the present invention may provide a set of candidates to the UE out of which the AI/ML HO prediction may determine the target cell. In contrast to that, state-of-the-art AI/ML for HO leaves the UE free to determine its target cell. This may potentially lead to decisions that are favorable for the UE but not for the network. For example, certain cells or base stations may be crowded or overloaded. Even, if the UE determines that the signal quality of these is very good, the cells may not be able to provide sufficient resources to the UE leading to a degraded user experience.

In accordance with embodiments, by applying or considering more relaxed handover (HO) conditions, configurations and/or thresholds a certain level of flexibility for AI/ML models and/or functionalities is implemented, e.g., for enhancing their ability to generalize effectively in diverse and dynamic environments. This avoids a suboptimal performance of conventional AI models for which that some scenarios are not fully reflective of the training conditions and/or configurations.

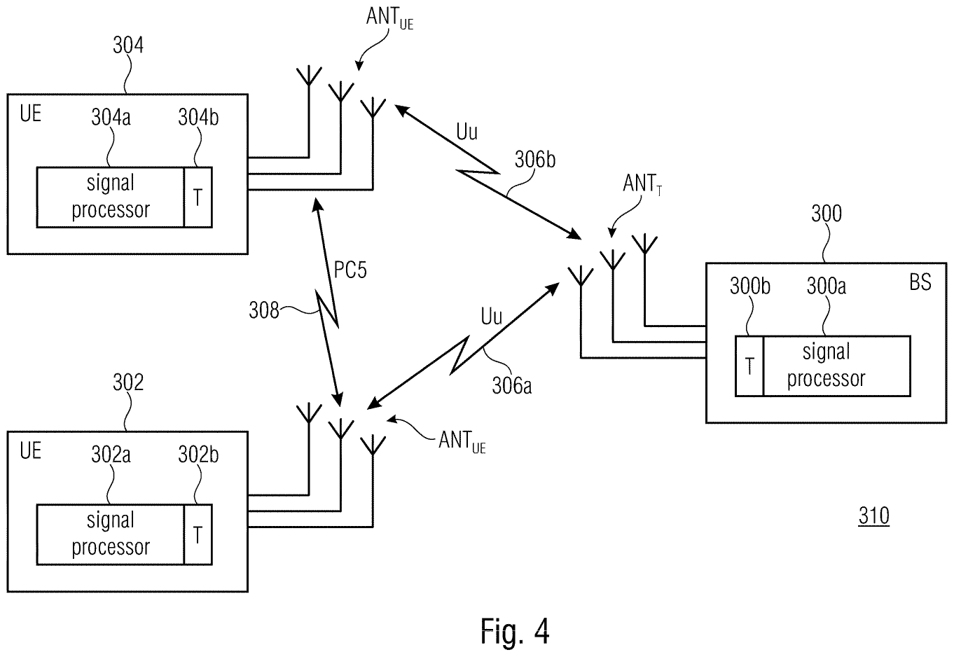

Embodiments of the present invention may be implemented in a wireless communication system as depicted in FIG. 1 including base stations and users, like mobile terminals or IoT devices. FIG. 4 is a schematic representation of a wireless communication system 310 including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 4, the one or more UEs 302, 304 of FIG. 4, and the base station 300 of FIG. 4 may operate in accordance with the inventive teachings described herein.

### User Device, UE

The present invention provides a user device, UE, for a wireless communication network,

wherein the UE is configured or preconfigured to be handed over from the source cell of the wireless communication network to a target cell of the wireless communication network, and

wherein the UE is to use at least one Artificial Intelligence/Machine Learning, AI/ML, handover, HO, model or at least one AI/ML HO functionality for performing one or more of the following:
selecting from a set of target cells one or more target cells suitable for a handover,
determining a suitability of one or more target cells for a handover.

In accordance with embodiments, the UE is to
signal to the source base station the target cells selected from the set and/or determined to be suitable for a handover, receive from the source base station a handover command including one or more available target cells and one or more conditions for the handover, and trigger the HO to one of the available target cells responsive to the one or more conditions being fulfilled, or
signal to the source base station the target cells selected from the set and/or determined to be suitable for a handover, receive from the source base station a handover command including one or more available target cells for the handover, and trigger the HO to one of the available target cells, or
trigger the HO from the source cell to one of the target cells selected from the set or determined to be suitable for a handover.

In accordance with embodiments, an input of the AI/ML HO model or functionality comprises measurement data and/or non-measurement data, and wherein the AI/ML HO model or functionality is to select the one or more target cells suitable for the handover using the measurement data and/or non-measurement data.

In accordance with embodiments, the UE is to obtain the measurement data by performing one or more measurements:
on the set of the target cells, or
on the source cell, or
on the source cell and on the set of the target cells.

In accordance with embodiments, the one or more measurements comprise one or more of the following:
radio resource measurements, e.g.,
   a reference signal received power, RSRP, measurement, or
   a reference signal received quality, RSRQ, measurement, or
   signal to noise and interference ratio, SINR, measurement,
performance measurements in the uplink and/or in the downlink, e.g.,
   throughput measurements, or
   latency measurements, or
   packet delay measurements, like a propagation delay, a queueing delay or an access delay, or
   packet loss measurements, or
   error rates, e.g., packet error rate, PER, or HARQ statistics, e.g., number of HARQ-NACKs transmitted and/or received,
   resource utilization measurements,
   jitter measurements,
mobility measurements, e.g.,
   a number of handovers, or
   a number of inter- or intra-gNB handovers, or
   a timing advance, or
   a Doppler spread of a received signal, or
   an angular spread of a received signal,
beam-related measurement, e.g.,
   a beam identifier, e.g., a beam index of a received beam in a certain location,
   a value associated with a beam failure, e.g., a beam index of a received beam and an associated beam failure in case this beam was previously used, e.g., in a certain location,
   a width of a beam, which depends on the carrier frequency and pre-coder used on a said beam,
measurements of one or more channel conditions of a radio channel between the UE and a radio access network, RAN, of the wireless communication network, e.g.,
   a line-of-sight, LOS, or non-LOS, NLOS, or
   one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
   one or more CQI and CSI measurements, or
   a pathloss.

In accordance with embodiments, the non-measurement data comprises one or more of the following:
assistance information provided to the UE from one or more network entities of the wireless communication system, e.g., by one or more further base stations and/or by one or more further UEs,
assistance information determined at the UE.

In accordance with embodiments, the assistance information provided to the UE comprises one or more of the following:
information about a configuration of a site at which the UE is located, e.g.,
   a bandwidth or bandwidth part used for the communication, or
   a carrier frequency or carrier selection in case of scenarios involving carrier aggregation, CA, e.g., a primary cell, PCell, or one or more secondary cells SCells, or
   a carrier configuration or bandwidth part configuration, e.g., numerology for OFDM, or
   an antenna configuration, e.g., number of antennas, antenna settings (e.g., MIMO), or
   a modulation and coding scheme information, or
   a gNB beam codebook, or
   a gNB virtualization configuration, or
   a transmission power,
   resource usage in another radio access technology, RAT, e.g., information from LTE provided by an in-device coexistence framework,
   or a resource pool, e.g., the UE may also additionally communicate in Mode 1 via sidelink, PC5, and may utilized resources of a transmit and/or receive and/or exceptional resource pool,
information about beamforming performed at the UE and/or at a UE's communication partner, e.g.,
   a beam direction, or
   codebook information, e.g., a type of a precoder or a precoding index, or
   beam index,
information about quality of service, QoS, conditions, or information on supported services in the one or more target cells,
information about a cell load and/or a cell congestion of the source and/or target cells,
information on the type of target cell, e.g., IAB or relay node, or NTN cell, e.g., the NTN cell may have a large coverage area to guarantee connectivity but may have much larger packet delays.
information about a geographical region or location where the UE is located, e.g.,
   a communication range, like a distance from another entity of the wireless communication network device in terms of a minimum required communication range, MCR,
   a location of the UE, e.g. GPS, GLONASS, BEIDOU, GALILEO,
   information about the PLMN,
   information about the paging area,
   information about the cell, beam,
   information about RAN-based Notification Area, RNA,
   information about an AI zone or area,
   information on a minimum required communication range, MCR,
information about a scenario in which the UE is employed, e.g.,
   a scenario type, like urban, suburban, rural, indoors, outdoors, terrestrial, non-terrestrial, airborne, or
   a cell type, like macro, micro, pico-cell, or
   a UE density and distribution in the UE's environment.
a speed at which the UE travels,
an elevation angle of the UE,
changes in altitude or vertical motion of the UE,
changes in coordinates of a UE position, e.g., changes in GPS or location coordinates to analyze differences in latitude and longitude (please clarify),
a direction of movement of the UE, e.g., an angle and/or an orientation of the UE in relation to a specific reference point or coordinate system,
beamforming information, e.g., a beam shape and/or a beam pattern, a selected beam index, rank information, a preferred-matrix index, a precoder matrix indictor, PMI, a feedback, a potential beam recovery procedure,
statistical information, e.g., a delay spread, an angular spread, a Doppler shift, line of sight, LOS, and/or non-LOS, NLOS, information,
quality information, like channel quality information of channel state information, CSI, e.g., SNR/SINR/RSRP/RSRQ/RSSI, quantized CSI or compressed CSI, e.g., Doppler-delay precoded CSI feedback,
performance measurements, e.g., a throughput, a latency, a packet delay, a packet loss, a packet error rate, a bit error rate, HARQ statistics, e.g., ACK/NACK ratios, or a number of NACK-only feedback,
a base station IDs, e.g., cell IDs that a UE may decode, e.g., by decoding system information blocks, SIBs, or the top-m or m strongest BS IDs from a plurality of BD

IDs,
AI/ML-related information, e.g., a prediction of any of the above-mentioned information, transmitted as a value, a vector, or a bitmap,
a prediction of a next possible BS to perform a handover to, e.g., top-m or m-best BS candidates for a conditional handover, CHO,
a compressed neural net, e.g., a pre-trained neural net containing a mobility model of the UE and parameters defining the neural net.

In accordance with embodiments, the assistance information determined at the UE comprises one or more of the following:
a UE speed, e.g., a speed category like high-speed, low speed, walking speed, e.g. pedestrian UE (P-UE),
an elevation angle, changes in altitude or vertical motion
a change in coordinates, e.g. changes in GPS or location coordinates to analyze differences in latitude and/or longitude,
a change in location, e.g., a UE moving from outdoor to indoor or vice versa, or a UE moving from indoor to deep indoor, e.g., depending on the path loss or signal obstruction measured at a UE,
a direction of movement, e.g. angle/orientation in relation to a specific reference point or coordinate system
information about a UE motion and orientation based on UE internal methods, e.g. GPS, accelerometer/gyroscope, position of the UE,
information about a past mobility of the UE, e.g., attached cell IDs, thresholds triggered, UE configurations.

In accordance with embodiments, the UE is configured or preconfigured with the set of target cells, e.g., receives the set of target cells from a source base station of the source cell.

In accordance with embodiments, the UE is configured or preconfigured with one or more minimum conditions for triggering the handover, and wherein the set of target cells comprises a plurality of target cells fulfilling the one or more minimum conditions.

In accordance with embodiments, the minimum conditions comprise one or more of the following:
a power threshold, e.g., CQI, RSRP, RSRQ, SINR, SNR,
a hysteresis offset,
a distance to the associated target cell, e.g., 2D-distance, 3D-distance,
a threshold on the interference level,
a gNB configuration, e.g., beam codebook, rural, urban, antenna configuration,
a gNB location or area, e.g., the UE may be barred from accessing certain gNBs that are in a specific area,
a performance threshold for the current cell or cell group, e.g., a throughput threshold, a delay threshold, a HARQ threshold (number or ratio of ACKs or NACKs in a certain time window for one or more cells),
a threshold on past performance values or statistics, e.g., related to Radio Link Failure, RLF, Beam Link Failure, BLF, Handover Failure, HOF in the past, e.g., in a certain time window, ping-pong effects,
a beam threshold and/or minimum suitable beam number, e.g., a certain number of beams have to be above a certain power level,
a threshold on the battery level, e.g., UE should access a cell only if the battery drops below certain level or is above a certain level,
a supported QoS, e.g., the target may only support
a certain duration for the which the minimum conditions have to fulfilled before a UE considers a handover,
a certain duration for which the UE must stay in the current cell or cell group.

In accordance with embodiments, the AI/ML HO model or functionality provides for one or more target cells one or more AI/ML metrics, and

wherein the UE is to initiate the handover to one of the one or more target cells only when one or more of the AI/ML metrics associated to the said target cell, which are provided by the AI/ML HO model or functionality, are larger or smaller than a configured or preconfigured threshold or than the AI/ML metric for the current cell.

In accordance with embodiments, the AI/ML HO model or functionality provides for one or more target cells one or more AI/ML metrics, and

wherein the UE is to signal the one or more AI/ML metrics to the source base station.

In accordance with embodiments, the signal contains a handover request in addition to the AI/ML metric.

In accordance with embodiments, the UE is to
send the selected one or more target cells to a source base station of the source cell, and
receive from the source base station a signaling indicating one target cell, and
initiate the handover to the target cell indicated in the signaling from the source base station, or authorize the UE to perform a handover or conditional handover to the indicated target cell immediately or later or within a certain time duration.

In accordance with embodiments, in case of a timeout or in case the UE does not receive the signaling from the source base station, e.g., due to radio link failure to the source base station, the UE is to
initiate the handover to a primary target cell, e.g., listed as top-1 in a list of target cells previously send to a source base station of the source cell, or
perform a handover to a configured or preconfigured or default target cell, e.g., a target cell operating in a lower frequency range or a target cell having a larger coverage area, e.g., a NTN-cell, or
refrain from performing a handover, or
switch to RRC_INACTIVE OR RRC_IDLE or RRC_AI_NON_CONNECTED.

In accordance with embodiments, the source base station comprises a central Unit, CU, and a distributed Unit, DU.

In accordance with embodiments, UE is to use the AI/ML HO model or functionality responsive to one or more predefined triggers, e.g., responsive to one or more of the following:
one or more measured parameters are below a certain level, like RSRP, RSRQ or SINR,
the UE is in a certain area or at a certain location,
the UE travels at a certain speed and direction,
an interference level exceeds a certain threshold,
a network congestion exceeds a configured or preconfigured threshold,
a number of unsuccessful data transmissions from the UE to one or more entities exceeds a configured or preconfigured threshold, e.g., a number of Hybrid automatic repeat request non-acknowledgements, HARQ-NACKs,
a number of successful data transmissions from the UE to one or more entities drops below a configured or preconfigured threshold, e.g., a number of Hybrid automatic repeat request acknowledgements, HARQ-ACKs,
a ratio of successful and unsuccessful data transmissions from the UE to one or more entities exceeds a configured or preconfigured threshold, e.g., ratio of HARQ-ACKs to HARQ-NACKs,
a configured or preconfigured number of SIB decoding attempts fail,
a configured or preconfigured number of RACH attempts fail,
receiving assistance information from another UE, e.g., directly with PC5 or indirectly via Uu.

In accordance with embodiments, the UE is configured or preconfigured with a handover configuration, wherein the handover configuration comprises for each of the target cells
the one or more AI/ML metric configurations, e.g., that the AI/ML metric is a handover probability or a confidence level or a handover failure probability or a handover failure confidence level or a RLF probability or a RLF confidence level, and
for each of the one or more AI/ML metrics a definition when the AI/ML metric triggers a handover or makes the target cell suitable for handover, e.g., an AI/ML handover probability threshold to be exceeded for a handover to be triggered or the target cell to be considered by another AI as a potential target cell candidate.

In accordance with embodiments, a plurality of the AI/ML HO models or functionalities are provided, and wherein
the UE is configured or preconfigured with the plurality of the AI/ML HO models or functionalities, and is to determine one or more of the plurality of AI/ML HO models or functionalities to be used by the UE responsive to
   receiving from the source base station a signaling that specifies the one or more AI/ML HO models or functionalities to be used by the UE, e.g., an AI/ML HO model or functionality ID, and/or
   information about a position of the UE e.g., by selecting one or more AI/ML HO models or functionalities associated with a cell ID, a zone and/or paging area, and/or
the UE is to receive from the source base station
   one or more of the plurality of AI/ML HO models or functionalities to be used by the UE, and/or
   an update, like updated parameters, for one or more AI/ML HO models or functionalities currently used by the UE.

In accordance with embodiments, the information about a position of the UE comprises one or more of the following:
information about a geographical region or location where the UE is located, e.g.,
   a communication range, like a distance from another entity of the wireless communication network device in terms of a minimum required communication range, MCR,
   a location of the UE, e.g. GPS, GLONASS, BEIDOU, GALILEO,
   information about the PLMN,
   information about the paging area,
   information about the cell, beam,
   information about RAN-based Notification Area, RNA,
   information about an AI zone or area,
information about a scenario in which the UE is employed, e.g.,
   a scenario type, like urban, suburban, rural, indoors, outdoors, or
   a cell type, like macro, micro, pico-cell, non-terrestrial, NTN, or
   a UE density and distribution in the UE's environment.

In accordance with embodiments, the UE is to send to the source base station or to another UE assistance information.

In accordance with embodiments, the assistance information comprises one or more of the following:
a speed at which the UE travels,
an elevation angle of the UE,
changes in altitude or vertical motion of the UE,
changes in coordinates of a UE position, e.g., changes in GPS or location coordinates to analyze differences in latitude and longitude (please clarify),
a direction of movement of the UE, e.g., an angle and/or an orientation of the UE in relation to a specific reference point or coordinate system,
beamforming information, e.g., a beam shape and/or a beam pattern, a selected beam index, rank information, a preferred-matrix index, a precoder matrix indictor, PMI, a feedback, a potential beam recovery procedure,
statistical information, e.g., a delay spread, an angular spread, a Doppler shift, line of sight, LOS, and/or non-LOS, NLOS, information,
quality information, like channel quality information of channel state information, CSI, e.g., SNR/SINR/RSRP/RSRQ/RSSI, quantized CSI or compressed CSI, e.g., Doppler-delay precoded CSI feedback,
performance measurements, e.g., a throughput, a latency, a packet delay, a packet loss, a packet error rate, a bit error rate, HARQ statistics, e.g., ACK/NACK ratios, or a number of NACK-only feedback,
a base station IDs, e.g., cell IDs that a UE may decode, e.g., by decoding system information blocks, SIBs, or the top-m or m strongest BS IDs from a plurality of BD IDs,
AI/ML-related information, e.g., a prediction of any of the above-mentioned information, transmitted as a value, a vector, or a bitmap,
AI/ML model ID and/or functionality ID,
a prediction of a next possible BS to perform a handover to, e.g., top-m or m best BS candidates for a conditional handover, CHO,
a compressed neural net, e.g., a pre-trained neural net containing a mobility model of the UE and parameters defining the neural net.

In accordance with embodiments, the UE is to send the assistance information when one or more conditions are met.

In accordance with embodiments, the one or more conditions comprise on or more of the following:
a speed of the UE has changed, e.g., the speed reached of dropped below a certain threshold,
a type of the UE related to speed has changed, e.g. a person carrying the UE is no longer with in a vehicle but is now a pedestrian or uses a bicycler,
a change in motion exceeds a configured or preconfigured threshold, e.g., a change in elevation angle, altitude or vertical motion, or in GPS coordinates,
a signal strength of a radio signal, e.g. SNR/SINR/RSRP/RSRQ/RSSI drops below a configured or preconfigured threshold or drops during a predefined time period by more than a configured or preconfigured amount,
a number of unsuccessful data transmissions from the UE to the one or more entities exceeds a configured or preconfigured threshold, e.g., a number of Hybrid automatic repeat request non-acknowledgements, HARQ-NACKs,
an interference level detected on the communication link exceeds a configured or preconfigured threshold,
the UE is in a certain location/area,
the UE is communicating on a certain frequency band, e.g. FR2 or FR3,
a number of Radio Link Failures, RLFs, or of Beam Link Failures, BLFs, exceeds a configured or preconfigured threshold,
one or more CHO conditions have not been fulfilled for a predefined time after a CHO command has been sent,
the UE is performing a HO, a CHO or a LTM-HO to a different cell, e.g., in case of a CHO assistance information may be included when a UE registers at the new cell, e.g., before or after successful connection establishment at the new cell,
the UE receives certain beam-related information, e.g., detects a new beam index, e.g., a better beam to be used.

In accordance with embodiments, the UE is to send the assistance information responsive to a request from the BS or from another UE.

In accordance with embodiments, the UE is to indicate a speed at which the UE moves to the source base station or to another UE.

In accordance with embodiments, the UE is to estimate the speed at which the UE moves based on one or more of the following:
network measurements, e.g. a Doppler shift, a time-of-flight, ToF, measurement, a RSSI, a triangulation based on cell IDs or based on UE IDs measured within its vicinity,
internal methods, e.g. using GPS unit for detecting changes in location over time, or using an accelerometer and/or gyroscope for detecting changes in motion and orientation,
data received from the core network, CN, e.g., from the LMF,
beams, e.g., based on reference signals received from a MIMO or distributed MIMO system, e.g., from a multi-TRP and phase correlations calculated from the one or more co-locate or distributed multi-TRPs,
using a sidelink positioning framework.

In accordance with embodiments, each of a plurality of different speed ranges is represented by an associated speed type.

In accordance with embodiments, the UE is to indicate the speed to the source base station responsive to one or more of the following:
a request from the source base station,
a change of the speed, e.g., changes by more than a configured or preconfigured amount or changes during a predefined time period by more than a configured or preconfigured amount, like in case a person is leaving a vehicle,
a change of location of the UE, e.g., moving from outdoor to indoor or vice versa, or when moving into a tunnel or street canyon.

In accordance with embodiments,
use of the AI/ML HO model or functionality takes precedence over a conventional HO process,
use of the AI/ML HO model or functionality takes precedence over a conventional CHO process,
use of the AI/ML HO model or functionality causing the UE to initiate the handover responsive to one or more of the AI/ML metrics being met takes precedence over use of the AI/ML HO model or functionality causing the UE to initiate the handover responsive to receiving from the source base station a signaling indicating one target cell.

In accordance with embodiments, the source cell and/or the target cell comprises one or more of the following:
a beam,
a transmission/reception point, TRP, e.g., a multi-TRP like a co-located or distributed multi-TRP,
a cell, e.g., a sector of a base station or gNB, or a Primary Cell, PCell, or a Secondary Cell, SCell,
a base station or gNB,
a relay node,
an Integrated Access and Backhaul, IAB, node,
a UE, e.g., in case a UE moves out of coverage of base station, it may connect via sidelink PC5 to another UE.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### Base Station/gNB

The present invention provides a base station, BS, for a wireless communication network,

wherein the BS is a source base station of a source cell and serves a user device, UE, of the wireless communication network, located in the source cell, UE being configured or preconfigured to be handed over from the source cell to a target cell of the wireless communication network, and

wherein the BS is to use at least one Artificial Intelligence/Machine Learning model, AI/ML, handover, HO, model or at least one AI/ML HO functionality for performing one or more of the following:
selecting one or more target cells suitable for a handover of the UE.
determining a suitability of one or more target cells for a handover of the UE.

In accordance with embodiments, the BS is to select the one or more target cells suitable for the handover of the UE responsive to a request received from the UE and/or from a further base station of the wireless communication network.

In accordance with embodiments, the BS is to
signal to the UE a handover command for initiating a handover of the UE, the handover command indicating one or more of the target cells selected from the set and/or determined to be suitable for the handover causing the UE to be handed over to one of the target cells, or
signal to the UE the one or more target cells suitable for the handover so as to allow the UE to select the target cell.

In accordance with embodiments, the handover command indicates one or more conditions for performing the HO, e.g., within a certain time frame determined, e.g. by a timeout of a timer.

In accordance with embodiments, an input of the AI/ML HO model or functionality comprises
measurement data obtained from the UE and/or from one or more other network entities of the wireless communication network, and/or
non-measurement data obtained from the UE and/or from one or more other network entities of the wireless communication network, and

wherein the AI/ML HO model or functionality is to select the one or more target cells suitable for the handover using the measurement data and/or the non-measurement data.

In accordance with embodiments, the measurement data comprise one or more of the following:
radio resource measurements, e.g.,
   a reference signal received power, RSRP, measurement, or
   a reference signal received quality, RSRQ, measurement, or
   signal to noise and interference ratio, SINR, measurement,
performance measurements in the uplink and/or in the downlink, e.g.,
   throughput measurements, or
   latency measurements, or
   packet delay measurements, like a propagation delay, a queueing delay or an access delay, or
   packet loss measurements, or
   resource utilization measurements, or
   jitter measurements,
mobility measurements, e.g.,
   a number of handovers, or
   a number of inter- or intra-gNB handovers, or
   a Doppler spread of a received signal, or
   an angular spread of a received signal,
measurements of one or more channel conditions of a radio channel between the UE and a radio access network, RAN, of the wireless communication network, e.g.,
   a line-of-sight, LOS, or non-LOS, NLOS, or
   one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
   one or more CQI and CSI measurements, or
   a pathloss.

In accordance with embodiments, the non-measurement data comprise one or more of the following:
information about a communication condition of the UE,
assistance information received from the UE and/or from one or more other network entities of the wireless communication network,
information about a position of the UE,
data on one or more earlier handover processes.

In accordance with embodiments, the assistance information comprises one or more of the following:
a speed at which the UE travels,
an elevation angle of the UE,
changes in altitude or vertical motion of the UE,
changes in coordinates of a UE position, e.g., changes in GPS or location coordinates to analyze differences in latitude and longitude (please clarify),
a direction of movement of the UE, e.g., an angle and/or an orientation of the UE in relation to a specific reference point or coordinate system,
beamforming information, e.g., a beam shape and/or a beam pattern, a selected beam index, rank information, a preferred-matrix index, a precoder matrix indictor, PMI, a feedback, a potential beam recovery procedure,
statistical information, e.g., a delay spread, an angular spread, a Doppler shift, line of sight, LOS, and/or non-LOS, NLOS, information,
quality information, like channel quality information of channel state information, CSI, e.g., SNR/SINR/RSRP/RSRQ/RSSI, quantized CSI or compressed CSI, e.g., Doppler-delay precoded CSI feedback,
performance measurements, e.g., a throughput, a latency, a packet delay, a packet loss, a packet error rate, a bit error rate, HARQ statistics, e.g., ACK/NACK ratios, or a number of NACK-only feedback,
a base station IDs, e.g., cell IDs that a UE may decode, e.g., by decoding system information blocks, SIBs, or the top-m or m strongest BS IDs from a plurality of BD IDs,
AI/ML-related information, e.g., a prediction of any of the above-mentioned information, transmitted as a value, a vector, or a bitmap,
a prediction of a next possible BS to perform a handover to, e.g., top-m or m best BS candidates for a conditional handover, CHO,
a compressed neural net, e.g., a pre-trained neural net containing a mobility model of the UE and parameters defining the neural net.

In accordance with embodiments, the BS is to train the AI/ML HO model or functionality using the assistance information.

In accordance with embodiments, the BS is to use the assistance information for AI/ML training/inference of the AI/ML HO model or functionality for one or more of the following:
enhancing one or more of the following: a handover, HO, prediction, a conditional handover, CHO, prediction, a L1/L2 Triggered Mobility, LTM, handover prediction,
enhancing candidate prediction in HO, CHO and LTM,
enhancing beam prediction in HO, CHO and LTM,
tuning of one or more HO parameters, e.g., tuning of a hysteresis margin or an HO margin used to avoid ping-pong effects,
enhancing a prediction of a HO in a NR-Unlicensed Spectrum, e.g. by improving an accuracy of a Listen-Before-Talk, LBT, result,
enhancing a prediction of a HO in a Non-Terrestrial Network, NTN, including, e.g., high altitude platforms, HAPs, in which both UE and NW operate in motion,
enhancing a Finite Impulse Response, FIR, filtering of L1 measurements,
enhancing an Infinite Impulse Response, IIR, filtering of L3 measurements,
enhancing HO failure prediction,
enhancing Radio Link Failure, RLF prediction,
enhancing measurement events prediction.

In accordance with embodiments, the BS is to receive the assistance information from the UE or another UE or another base station or the core network, CN, when one or more conditions are met.

In accordance with embodiments, the one or more conditions comprise on or more of the following:
a speed of the UE has changed, e.g., the speed reached of dropped below a certain threshold,
a type of the UE related to speed has changed, e.g. a person carrying the UE is no longer with in a vehicle but is now a pedestrian or uses a bicycler,
a change in motion exceeds a configured or preconfigured threshold, e.g., a change in elevation angle, altitude or vertical motion, or in GPS coordinates,
a signal strength of a radio signal, e.g. SNR/SINR/RSRP/RSRQ/RSSI drops below a configured or preconfigured threshold or drops during a predefined time period by more than a configured or preconfigured amount,
a number of unsuccessful data transmissions from the UE to the one or more entities exceeds a configured or preconfigured threshold, e.g., a number of Hybrid automatic repeat request non-acknowledgements, HARQ-NACKs,
an interference level detected on the communication link exceeds a configured or preconfigured threshold,
the UE is in a certain location/area,
the UE is communicating on a certain frequency band, e.g. FR2 or FR3,
a number of Radio Link Failures, RLFs, or of Beam Link Failures, BLFs, exceeds a configured or preconfigured threshold,
one or more CHO conditions have not been fulfilled for a predefined time after a CHO command has been sent,
the UE is performing a HO, a CHO or a LTM-HO to a different cell, e.g., in case of a CHO assistance information may be included when a UE registers at the new cell, e.g., before or after successful connection establishment at the new cell.

In accordance with embodiments, the BS is to request the assistance information from the UE.

In accordance with embodiments, the BS is to request the assistance information from the UE based on one or more of the following:
a timer, e.g.,
   when the assistance information available at the BS is outdated or has a certain age, or
   at regular timer intervals,
an event, e.g.,
   when the UE transmits a HO request to the network, or
   when the UE moves into a certain area or location,
previous assistance information, e.g.,
   when the UE reports a change in location, or
   on the current CSI, like in case of a sudden higher pathloss causing the BS to assume that the UE has moved indoors.

In accordance with embodiments, the information about the communication condition comprises one or more of the following:
information about a configuration of a site at which the UE is located, e.g.,
   a bandwidth or bandwidth part used for the communication, or
   a carrier frequency or carrier selection in case of scenarios involving carrier aggregation, CA, or
   a carrier configuration or bandwidth part configuration, e.g., a numerology for OFDM, or
   an antenna configuration, e.g., a number of antennas, an antenna setting, like MIMO, or
   modulation and coding scheme, MCS, information, or
   a gNB beam codebook, or
   a gNB virtualization configuration, or
   a transmission power,
information about beamforming performed at the UE and/or at a UE's communication partner, e.g.,
   a beam direction, or
   codebook information,
information about quality of service, QoS, conditions,
information about a cell load and/or a cell congestion of the source and/or target cells.

In accordance with embodiments, the information about a position of the UE comprises one or more of the following:
information about a geographical region or location where the UE is located, e.g.,
   a communication range, like a distance from another entity of the wireless communication network device in terms of a minimum required communication range, MCR,
   a location of the UE, e.g. GPS, GLONASS, BEIDOU, GALILEO,
   information about the PLMN,
   information about the paging area,
   information about the cell, beam,
   information about RAN-based Notification Area, RNA,
   information about an AI zone or area,
information about a scenario in which the UE is employed, e.g.,
   a scenario type, like urban, suburban, rural, indoors, outdoors, or
   a cell type, like macro, micro, pico-cell, or
   a UE density and distribution in the UE's environment.

In accordance with embodiments, the data on one or more earlier handover processes comprise one or more of the following:
information from prior handover processes performed in a specific area,
information from prior handover processes performed in a specific time slot,
information from one or more neighboring cells involved in a HO process, e.g., a cell ID,
information on a ratio of HO success/failure when executing a HO,
information on conditions or thresholds that triggered handovers, e.g., timers, measurements,
information on previous ping-pong effects, e.g., the UE frequently switched between two cells,
information on the duration for which a UE was attached to the base station and/or neighboring cells.

In accordance with embodiments, for obtaining the data on one or more earlier handover processes, the BS is to perform one or more of the following:
model a physical layout or topology of the environment of the BS, e.g., for determining how stable physical elements are arranged,
create a database for a specific environment, e.g., by utilizing assistance information obtained from the UE and/or from one or more other network entities of the wireless communication network, like sensors,
collect and store assistance information obtained from the UE and/or from one or more other network entities of the wireless communication network over different times to model an environmental dynamism, e.g., for weekdays, a weekend, rush hours, and various times of the day,
collect and store data for periodic events which the BS is aware of and which are happening at specific time e.g., a traffic jam during the day,
train the AI/ML HO model or functionality by predicting handover patterns of UEs, e.g., previous and current handovers performed in a certain area for a certain time,
establish handover patterns of UEs in a certain area over a specific time period, e.g., training the AI/ML HO model or functionality to predict an optimal handover initiation time,
foresee a handover in advance based on real-time data and predictive analyses,
reduce a standard deviation of a probability distribution for increasing an accuracy of the AI/ML HO model or functionality.
update the AI/ML HO model or functionality, e.g., when changes occur in a topology, a dynamism and/or a UE behavior.

In accordance with embodiments, the BS is to prioritize one or more of the target cells suitable for the handover of the UE.

In accordance with embodiments, the BS is to prioritize:
target cells that have a potential to reduce or minimize an energy consumption of the UE, or
target cells that align with the traffic requirements of the UE, e.g., for ensuring a seamless user experience, or
target cells that are capable of meeting specific QoS and/or latency requirements, e.g., for addressing the need of the UE for a reliable and low-latency communication.

In accordance with embodiments, the BS is to
use the AI/ML HO model or functionality for predicting for one or more of the target cells suitable for the handover a beam ID and/or a beam configuration, and/or
provide the beam ID and/or the beam configuration to the UE, e.g., by including the beam ID and/or the beam configuration into the handover command.

In accordance with embodiments, the BS is to
receive from the UE a report including a measurement result of a measurement by the UE of multiple beams of target cells in a neighborhood of the UE,
determine, using the measurement result, a beam to be used for the respective target cells, and
provide the UE with one or more beams and/or beam configurations for the one or more target cells.

In accordance with embodiments, the respective beams are associated with one or more of the following:
a certain area,
a UE direction,
a UE speed.

In accordance with embodiments, one or more of the following applies:
AI/ML HO and/or AI/ML CHO takes precedence over a conventional HO process,
a conventional HO process takes precedence over AI/ML HO and/or AI/ML CHO,
AI/ML HO and/or AI/ML CHO takes precedence over a conventional CHO process,
a conventional CHO process takes precedence over the use of the AI/ML HO and/or AI/ML CHO,
AI/ML HO and/or AI/ML CHO causing the UE to initiate the handover responsive to one or more AI/ML metrics being met takes precedence over AI/ML HO and/or AI/ML CHO causing the UE to initiate the handover responsive to receiving from the BS a signaling indicating a target cell.

In accordance with embodiments, the network entity comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### System

The present invention provides a wireless communication network, like a 3^{rd} Generation Partnership Project, 3GPP, system, comprising a one or more user devices, UEs, in accordance with embodiments of the present invention and/or one or more base stations, BSs, in accordance with embodiments of the present invention.

### Methods

The present invention provides a method for operating a user device, UE, for a wireless communication network, wherein the UE is configured or preconfigured to be handed over from the source cell of the wireless communication network to a target cell of the wireless communication network, the method comprising:

using, by the UE, at least one Artificial Intelligence/Machine Learning, AI/ML, handover, HO, model or at least one AI/ML HO functionality for performing one or more of the following:
selecting from a set of target cells one or more target cells suitable for a handover,
determining a suitability of one or more target cells for a handover.

The present invention provides a method for operating a user device, UE, for a wireless communication network, wherein the BS is a source base station of a source cell and serves a user device, UE, of the wireless communication network, located in the source cell, UE being configured or preconfigured to be handed over from the source cell to a target cell of the wireless communication network, the method comprising:

using, by the BS, at least one Artificial Intelligence/Machine Learning model, AI/ML, handover, HO, model or at least one AI/ML HO functionality for performing one or more of the following:
selecting one or more target cells suitable for a handover of the UE.
determining a suitability of one or more target cells for a handover of the UE.

### Computer Program Product

The present invention provides a computer program product comprising instructions which, when the program is executed by a computer, causes the computer to carry out one or more methods in accordance with the present invention.

Embodiments of the present invention are now described in more detail with reference to the accompanying drawing. It is noted that the subsequently outlined and described aspects or embodiments may be combined such that some or all of the aspects/embodiments are implemented within one embodiment. Reference is made herein one or more AI/ML models and/or to one or more AI/ML functionalities. It is noted that when referring only to an AI/ML model, this is to be understood to refer also to an AI/ML functionality, and that when referring only to an AI/ML functionality, this it to be understood to refer also to an AI/ML model. AI/ML functionality may refer to an AI/ML-enabled Feature/Feature Group, FG, enabled by one or more configurations, where the one or more configurations may be supported based on one or more conditions indicated by a UE capability. An AI/ML-enabled Feature refers to a Feature where AI/ML may be used. It is noted that a UE may have one AI/ML model for the functionality, or the UE may have multiple AI/ML models for the functionality.

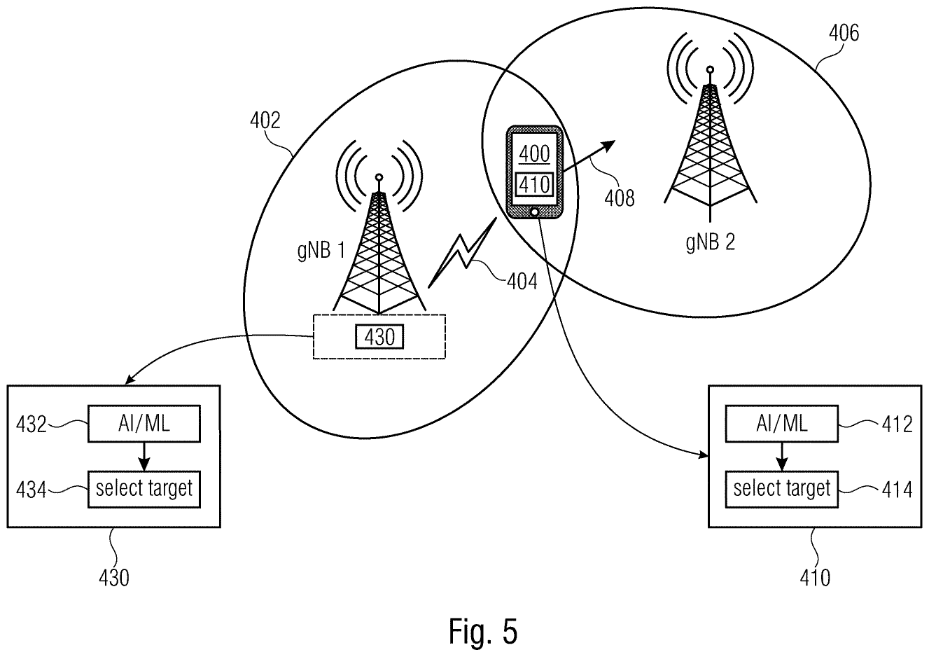

FIG. 5 illustrates a user device, UE, 400 in accordance with embodiments of the present invention. The UE 400 is served by a source base station gNB1 of a source cell 402 as is indicated at 404. A further cell 406 is served by a further based station gNB2. The UE 400 may be switched or handed over from the source cell 402 to the further cell 406, also referred to as the target cell, as is schematically illustrated by the arrow 408. In accordance with embodiments of the present invention, the UE 400, which is configured or preconfigured to be handed over from the source cell 402 to the target cell 406, uses at least one Artificial Intelligence/Machine Learning, AI/ML, handover, HO, model, or functionality for selecting from a set of target cells one or more target cells suitable for a handover and/or for determining a suitability of one or more target cells for a handover. As is illustrated in FIG. 5, UE 400 may include a signal processing unit 410 for implementing the AI/ML HO model or functionality 412 used for selecting from a set of target cells one or more target cells suitable for a handover and/or for determining a suitability of one or more target cells for a handover, as is indicated at 414.

In accordance with embodiments, the UE 400 signals to the source base station gNB1 the target cells selected from the set and/or determined to be suitable for a handover. The UE receives from the source base station gNB1 a handover command including available target cells and one or more conditions for the handover. As has been described above, with regard to the conventional CHO process, the source base station asks the selected target cells to acknowledge a handover request by the UE so as to prepare the respective configurations to be used by the UE. This information is signaled in the handover command to the UE 400 together with the conditions triggering the handover. Once the handover command is received at the UE 400, the UE continues to operate with the source base station until the one or more conditions are fulfilled. Once the one or more conditions are fulfilled, the handover to one of the available target cells indicated in the handover command is triggered.

In accordance with embodiments, the AI/ML HO model or functionality may provide one or more AI/ML metrics for the one or more target cells. The UE 400 may signal the AI/ML metric to the source base station gNB1 for allowing the source base station gNB1 to determine to which of the target cells the associated AI/ML metrics is larger or smaller than a certain threshold. For those target cells for which the AI/ML metrics is larger than a threshold, for example a handover probability exceeds a certain threshold, the base station gNB1 asks the respective target base stations to acknowledge a handover so as to obtain the respective configurations to be used by the UE 400 for accessing the target cell.

In accordance with embodiments, the signaling of the AI/ML metric may include the signaling of a handover request that is forwarded to the respective target cells by the source base station gNB1 for obtain the respective configurations once the target cells have acknowledged the handover request.

In accordance with embodiments, the UE 400 is configured or preconfigured with one or more handover configurations. A handover configuration may include for each of the target cells one or more AI/ML metric configurations, e.g., that the AI/ML metric is a handover probability or a confidence level or a handover failure probability or a handover failure confidence level or a RLF probability or a RLF confidence level. For each of the one or more AI/ML metrics the handover configuration includes the definition when the AI/ML metric triggers a handover or makes the target cell suitable for handover, e.g., an AI/ML handover probability threshold to be exceeded for a handover to be triggered or the target cell to be considered by another AI as a potential target cell candidate.

In accordance with embodiments, the UE 400 is configured with one or more CHO configurations that are enabled for a AI/ML HO prediction. The CHO configuration may also be referred to as an AI/ML-CHO configuration defining the AI/ML HO model or functionality to be used in accordance with the present invention and, optionally further AI/ML for improving the measurements in neighboring cells, for example for enhancing an accuracy of a measured parameter in CHO associated conditions and/or for predicting a target cell to be used with or without additional conditions.

The UE 400 may be configured to preconfigured with one or more minimum conditions, like the above described HO probability, for triggering a handover, and the set of target cells comprises those cells which fulfill the one or more minimum conditions. In other words, in accordance with this embodiment, the UE does not receive the target cells from another source but determines the target cells on its own using the one or more minimum conditions and applies the AI/ML HO model or functionality for selecting the suitable target cells for the handover. For example, the AI/ML-CHO configuration may be more relaxed than a conventional CHO configuration. Certain thresholds may be more relaxed or may even be optional. The AI/ML-CHO configuration may provide no condition at all or only the above-mentioned minimum condition so that, in contrast to a conventional CHO configuration, where only a single CHO configuration usually fulfills the handover conditions, when applying AI/ML-CHO configurations multiple cells may fulfill the minimum conditions. In accordance with the inventive approach, the AI/ML HO model or functionality selects or chooses out of a set of target cells those that fulfill the minimum conditions.

In accordance with embodiments, the minimum conditions may include one or more of the following:
A power threshold, e.g., CQI, RSRP, RSRQ, SINR, SNR. The power threshold may be absolute or may be relative to the power of the current cell.
A hysteresis offset.
A distance to the associated target cell, e.g., 2D-distance, 3D-distance.
A threshold on the interference level.
A gNB configuration, e.g., beam codebook, rural, urban, antenna configuration. The UE may look for certain gNB configurations as potential target cell candidates.
A gNB location or area, e.g., the UE may be barred from accessing certain gNBs that are in a specific area.
A performance threshold for the current cell or cell group, e.g., a throughput threshold, a delay threshold, a HARQ threshold (number or ratio of ACKs or NACKs in a certain time window for one or more cells).
A threshold on past performance values or statistics, e.g., related to Radio Link Failure, RLF, Beam Link Failure, BLF, Handover Failure, HOF in the past, e.g., in a certain time window, ping-pong effects.
A beam threshold and/or minimum suitable beam number, e.g., a certain number of beams have to be above a certain power level.
A threshold on the battery level, e.g., UE should access a cell only if the battery drops below certain level or is above a certain level.
A supported QoS, e.g., the target may only support
A certain duration for the which the minimum conditions have to fulfilled before a UE considers a handover.
A certain duration for which the UE must stay in the current cell or cell group. The UE shall not perform handovers too frequently. Hence, a minimum time duration for which the UE has to stay in a cell ensures that the UE does not prematurely switch again to another cell.

In accordance with other embodiments, the AI/ML-CHO configuration may only provide information on the target cell, for example respective RRC reconfigurations of the target cell, but no conditions at all, i.e., in accordance with other embodiments, the UE may simply signal to the source base station gNB1 the target cells selected from the set and/or determined to be suitable for the handover. The source base station gNB1 then asks the respective target cells for the acknowledgement of the handover request and signals to the UE 400 one or more available target cells for the handover so as to allow the UE, responsive to the handover command, to trigger a handover to one of the available target cells.

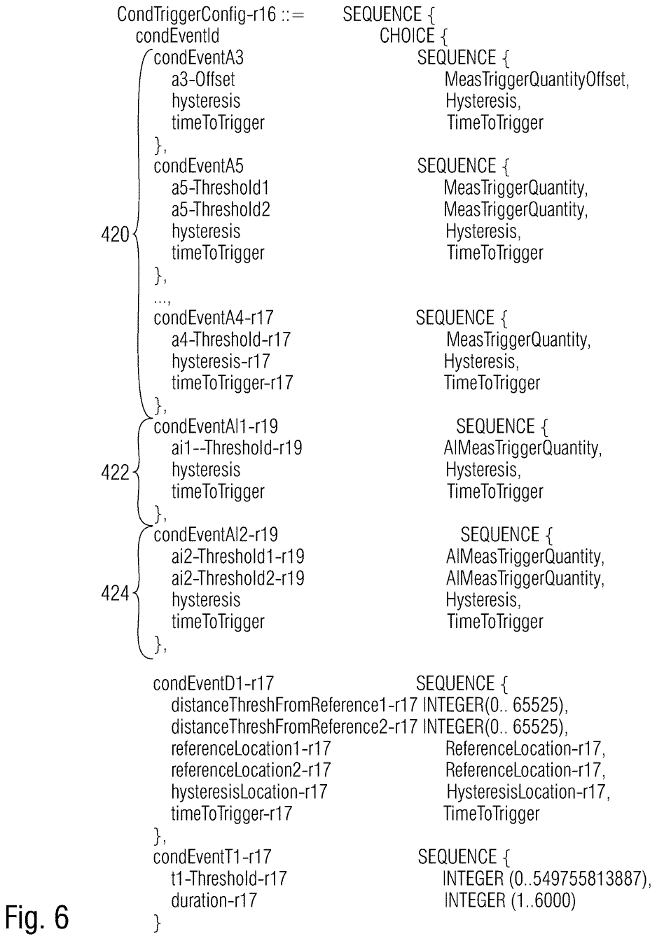

FIG. 6 illustrates an embodiment of an information element, IE, as it may be used for setting the conditions for triggering a conditional handover including, besides the conventional events A3, A4, A5 indicated at 420, also the additional events AI1 and AI2 indicated at 422 and 424 in FIG. 6. In accordance with the embodiment of FIG. 6, the AI/ML-CHO configuration may include as the additional AI/ML metric an AI/ML handover probability (MeasTriggerQuantiy) which may be floating point number having a value between 0 and 1, where 0 means that a handover is to be performed with a probability of 0. The new AI/ML HO event indicated in FIG. 6 at 422 and at 424 specifies the AI/ML metric, namely the AI/ML handover probability threshold, and the handover is triggered the specified thresholds are exceeded. Similar to the HO events A4 and A5, the new AI/ML events AI1 and AI2 may be triggered when the AI/ML output of the neighboring cell exceeds the AI1-threshold, and the AI/ML output of the serving cell is lower than the AI2-threshold while the AI/ML metric of the neighboring cell becomes larger than the AI2-threshold.

In accordance with embodiments, the AI/ML HO model or functionality provides for one or more of the target cells the one or more AI/ML metrics, and the UE 400 is to initiate the handover to one of the one or more target cells only when one or more of the AI/ML metrics associated with the set target cell, which are provided by the AI/MLHO model or functionality, are larger or smaller than a configured or preconfigured threshold or than the AI/ML metric for the current cell.

In accordance with embodiments of the present invention, the UE may operate in a similar way as during a conventional basic handover or during a conventional LTM-HO. The UE 400 triggers the handover from the source cell 402 to one of the target cells selected from the set or determined to be suitable for the handover. In other words, once the UE determines on its own that there is a suitable target cell, it may trigger the handover.

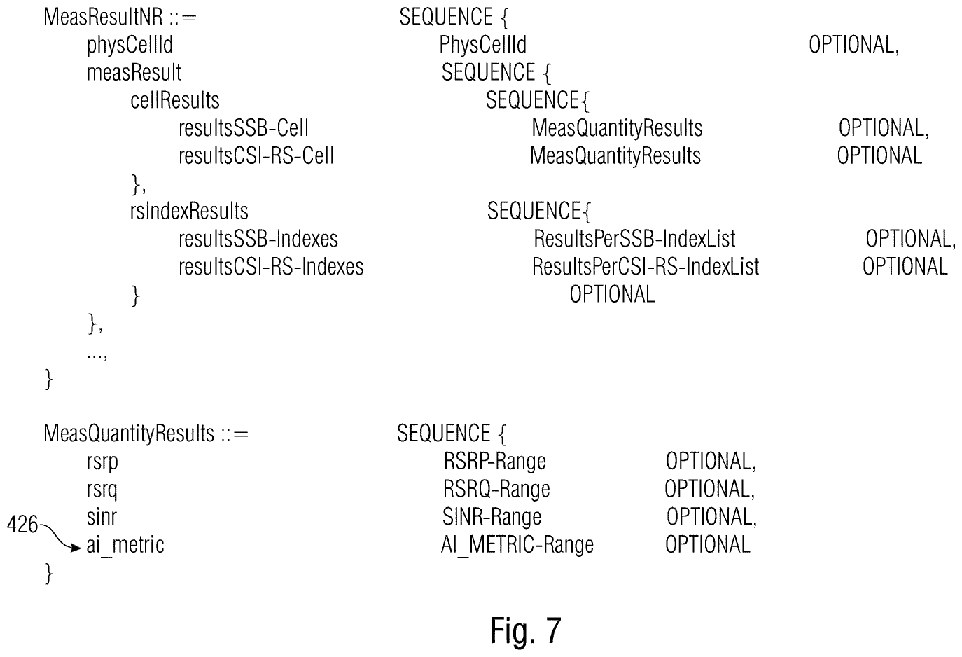

In accordance with embodiments, the UE 400 may be configured or preconfigured with one or more HO configurations also referred to as an AI/ML-HO configuration defining the AI/ML HO model or functionality to be used in accordance with the present invention and, optionally further AI/ML for improving the measurements in neighboring cells, for example for enhancing an accuracy of a measured parameter in CHO associated conditions and/or for predicting a target cell to be used with or without additional conditions. In a similar way as described above with reference to the conditional handover, also for the basic handover or the LTM-HO, the configuration may contain additional parameters, like an AI/ML metric. The AI/ML metric may be an AI/ML handover probability in the form of a floating point number having a value between 0 and 1, where 0 means that a handover is performed with a probability of 0. The AI/ML metric may be added to a measurement report and signaled along with the rest of the L1/L3 measured parameters to the serving base station. The base station, like gNB1, on the basis of the received AI/ML metrics determines the available target cells, provides the handover request to the available target cells and, after receiving an acknowledgement, sends the handover command including the available target cells, for example the respective formal configurations thereof, so as to allow the UE to be handed over to one of the target cells. FIG. 7 illustrates an embodiment of an information element, IE, defining the measurement report provided by the UE 400 to the base station gNB1. The measured quantity results include, in addition to the regular measurements also the AI metric, as is indicated at 426.

Thus, in accordance with embodiments, the inventive approach may support an AI/ML supported conventional handover process in accordance with which the UE 400 sends to the source base station gNB1 the one or more target cells which have been selected or determined suitable for a handover. The source base station gNB1 obtains from one or more of the selected or suitable target cells signaled by the UE 400 an acknowledgement indicating that a handover to the target cell is possible and provides a signaling, like a handover command, to the UE 400. The UE 400 receives from the source base station gNB1 the signaling or the handover command indicating at least one target cell. Responsive to the handover command or signaling the UE 400 initiates the handover to the target cell indicated in the signaling or authorizes the UE to perform a handover or conditional handover to the indicated target cell immediately or later or within a certain time duration.

In accordance with further embodiments, there may be situations in which the UE has sent the selected/suitable target cells, however, no answer is received from the source base station gNB1. In case no such signaling is received, for avoiding an interruption of the communication link, the UE 400 may initiate the handover to a primary target cell or to a configured or preconfigured or default cell. For example, in a situation in which a timeout occurred, i.e., a time period between sending the target cells to the source base station and the time at which a reply from the source base station is expected, exceeds a certain value, like a timer value, or in case no signal is received due to a radio link failure, RLF, such handover to a primary or default target cell may be initiated by the UE. The UE 400 may store a certain number of target cells previously sent to the source base station gNB1, for example in a chronological order or based on the RSRP level, and the primary target cell may be the first or top-1 target cell found in this list of previously sent target cells. The configured or preconfigured or default target cell may be a cell operating in a lower frequency range, or it may be a target cell having a larger cover area than the current cell 402. Such a target cell with a larger coverage area may be NTN-cell. Performing the handover to the primary target cell or to the configured or preconfigured or default target cell allows to keep the connectivity and avoid a radio link failure. In accordance with other embodiments, when no answer is received from the source base station gNB1, the UE may refrain from performing a handover, or may switch to an RRC_INACTIVE stat or an RRC_IDLE state or an RRC_AI_NON_CONNECTED state. In the RRC_AI_NON_CONNECTED state the UE is in a non-connected state but is allowed to use the AI/ML models/functionality with which the UE is configured/preconfigured.

In accordance with embodiments, for selecting a target cell or for determining a suitability of a target cell, measurement data and/or non-measurement data is fed to the AI/ML HO model or functionality of the UE 400. The measurement data may include data on the target cell and/or on the source cell, which may be obtained by performing measurements on the set of target cells, or on the source cell or on both the source cell and the set of target cells. The one or more measurements may comprise one or more of the following:
radio resource measurements, e.g.,
   a reference signal received power, RSRP, measurement, or
   a reference signal received quality, RSRQ, measurement, or
   signal to noise and interference ratio, SINR, measurement,
performance measurements in the uplink and/or in the downlink, e.g.,
   throughput measurements, or
   latency measurements, or
   packet delay measurements, like a propagation delay, a queueing delay or an access delay, or
   packet loss measurements, or
   error rates, e.g., packet error rate, PER, or HARQ statistics, e.g., number of HARQ-NACKs transmitted and/or received,
   resource utilization measurements,
   jitter measurements,
mobility measurements, e.g.,
   a number of handovers, or
   a number of inter- or intra-gNB handovers, or
   a timing advance, or
   a Doppler spread of a received signal, or
   an angular spread of a received signal,
beam-related measurement, e.g.,
   a beam identifier, e.g., a beam index of a received beam in a certain location,
   a value associated with a beam failure, e.g., a beam index of a received beam and an associated beam failure in case this beam was previously used, e.g., in a certain location,
   a width of a beam, which depends on the carrier frequency and pre-coder used on a said beam,
measurements of one or more channel conditions of a radio channel between the UE and a radio access network, RAN, of the wireless communication network, e.g.,
   a line-of-sight, LOS, or non-LOS, NLOS, or
   one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
   one or more CQI and CSI measurements, or
   a pathloss.

The non-measurement data may comprise one or more of the following:
assistance information provided to the UE from one or more network entities of the wireless communication system, e.g., by one or more further base stations and/or by one or more further UEs,
assistance information determined at the UE.

In accordance with embodiments, the assistance information provided to the UE comprises one or more of the following:
information about a configuration of a site at which the UE is located, e.g.,
   a bandwidth or bandwidth part used for the communication, or
   a carrier frequency or carrier selection in case of scenarios involving carrier aggregation, CA, e.g., a primary cell, PCell, or one or more secondary cells SCells, or
   a carrier configuration or bandwidth part configuration, e.g., numerology for OFDM, or
   an antenna configuration, e.g., number of antennas, antenna settings (e.g., MIMO), or
   a modulation and coding scheme information, or
   a gNB beam codebook, or
   a gNB virtualization configuration, or
   a transmission power,
   resource usage in another radio access technology, RAT, e.g., information from LTE provided by an in-device coexistence framework,
   or a resource pool, e.g., the UE may also additionally communicate in Mode 1 via sidelink, PC5, and may utilized resources of a transmit and/or receive and/or exceptional resource pool,
information about beamforming performed at the UE and/or at a UE's communication partner, e.g.,
   a beam direction, or
   codebook information, e.g., a type of a precoder or a precoding index, or
   beam index,
information about quality of service, QoS, conditions, or information on supported services in the one or more target cells,
information about a cell load and/or a cell congestion of the source and/or target cells,
information on the type of target cell, e.g., IAB or relay node, or NTN cell, e.g., the NTN cell may have a large coverage area to guarantee connectivity but may have much larger packet delays.
information about a geographical region or location where the UE is located, e.g.,
   a communication range, like a distance from another entity of the wireless communication network device in terms of a minimum required communication range, MCR,
   a location of the UE, e.g. GPS, GLONASS, BEIDOU, GALILEO,
   information about the PLMN,
   information about the paging area,
   information about the cell, beam,
   information about RAN-based Notification Area, RNA,
   information about an AI zone or area,
   information on a minimum required communication range, MCR,
information about a scenario in which the UE is employed, e.g.,
   a scenario type, like urban, suburban, rural, indoors, outdoors, terrestrial, non-terrestrial, airborne, or
   a cell type, like macro, micro, pico-cell, or
   a UE density and distribution in the UE's environment.
a speed at which the UE travels,
an elevation angle of the UE,
changes in altitude or vertical motion of the UE,
changes in coordinates of a UE position, e.g., changes in GPS or location coordinates to analyze differences in latitude and longitude (please clarify),
a direction of movement of the UE, e.g., an angle and/or an orientation of the UE in relation to a specific reference point or coordinate system,
beamforming information, e.g., a beam shape and/or a beam pattern, a selected beam index, rank information, a preferred-matrix index, a precoder matrix indictor, PMI, a feedback, a potential beam recovery procedure,
statistical information, e.g., a delay spread, an angular spread, a Doppler shift, line of sight, LOS, and/or non-LOS, NLOS, information,
quality information, like channel quality information of channel state information, CSI, e.g., SNR/SINR/RSRP/RSRQ/RSSI, quantized CSI or compressed CSI, e.g., Doppler-delay precoded CSI feedback,
performance measurements, e.g., a throughput, a latency, a packet delay, a packet loss, a packet error rate, a bit error rate, HARQ statistics, e.g., ACK/NACK ratios, or a number of NACK-only feedback,
a base station IDs, e.g., cell IDs that a UE may decode, e.g., by decoding system information blocks, SIBs, or the top-m or m strongest BS IDs from a plurality of BD IDs,
AI/ML-related information, e.g., a prediction of any of the above-mentioned information, transmitted as a value, a vector, or a bitmap,
a prediction of a next possible BS to perform a handover to, e.g., top-m or m-best BS candidates for a conditional handover, CHO,
a compressed neural net, e.g., a pre-trained neural net containing a mobility model of the UE and parameters defining the neural net.

The assistance information may be determined at the UE 400 and comprises one or more of the following:
a UE speed, e.g., a speed category like high-speed, low speed, walking speed, e.g. pedestrian UE (P-UE),
an elevation angle, e.g., a height, changes in altitude or vertical motion
a change in coordinates, e.g. changes in GPS or location coordinates to analyze differences in latitude and/or longitude and/or height,
a change in location, e.g., a UE moving from outdoor to indoor or vice versa, or a UE moving from indoor to deep indoor, e.g., depending on the path loss or signal obstruction measured at a UE,
a direction of movement, e.g. angle/orientation in relation to a specific reference point or coordinate system
information about a UE motion and orientation based on UE internal methods, e.g. GPS, accelerometer/gyroscope, position of the UE,
information about a past mobility of the UE, e.g., attached cell IDs, thresholds triggered, UE configurations.

In accordance with embodiments, the UE 400 may be configured of preconfigured with a set of target cells from the which the AI/ML HO model or functionality selects the suitable target cells for handover. For example, the UE 400 may receive the set of target cells from the source base station gNB1 of the source cell 402 or from one or more other base stations or from one or more other UEs. Thus, in accordance with this embodiment, the UE 400 does not perform the actual determination of the available target cells but receives from another source the available target cells and then determines, using its own AI/ML HO model or functionality which of the received target cells are actually suited for a handover.

In accordance with further embodiments of the present invention, the UE 400 may use the AI/ML HO model or functionality in the above-described way based on a predefined trigger. In other words, in accordance with such embodiments, the UE 400 implements or makes use of the AI/ML during the handover process only when one or more certain conditions are met. In accordance with embodiments, such conditions or triggers may include one or more of the following:
one or more measured parameters are below a certain level (absolute level or relative to the current cell), like RSRP, RSRQ or SINR, The power threshold may be absolute or may be relative to the power of the current cell.
the UE is in a certain area or at a certain location,
the UE travels at a certain speed and direction,
an interference level exceeds a certain threshold,
a network congestion exceeds a configured or preconfigured threshold,
a number of unsuccessful data transmissions from the UE to one or more entities exceeds a configured or preconfigured threshold, e.g., a number of Hybrid automatic repeat request non-acknowledgements, HARQ-NACKs,
a number of successful data transmissions from the UE to one or more entities drops below a configured or preconfigured threshold, e.g., a number of Hybrid automatic repeat request acknowledgements, HARQ-ACKs,
a ratio of successful and unsuccessful data transmissions from the UE to one or more entities exceeds a configured or preconfigured threshold, e.g., ratio of HARQ-ACKs to HARQ-NACKs,
a configured or preconfigured number of SIB decoding attempts fail,
a configured or preconfigured number of RACH attempts fail,
receiving assistance information from another UE, e.g., directly with PC5 or indirectly via Uu.

In accordance with embodiments of the present invention, the source base station gNB1 may indicate to the UE 400 an ID so as to allow the UE 400 to select and use an AI/ML HO model or functionality suitable for a certain situation.

In other words, the overall network provides for a plurality of available AI/ML-HO models or functionalities, and the UE is, for example, configured or preconfigured with this plurality and determines one or more of the plurality of AI/ML-HO models or functionalities to be used. For example, the UE may determine the AI/ML-HO model or functionality to be used responsive to a signaling from the source base station gNB1 specifying the one or more AI/ML-HO models or functionalities to be used, for example by signaling a certain identification. In accordance with other embodiments, the UE 400 may determine its position within the network, and on the basis of the information about its position, the UE 400 may select one or more appropriate AI/ML-HO models or functionalities, for example those associated with an identification of a cell or zone or paging area within which the UE is currently located. In accordance with yet other embodiments, the source base station gNB1 may transfer one or more suitable AI/ML-HO models or functionalities to the UE 400. In accordance with other embodiments, the source base station gNB1 may send an update with regard to the AI/ML-HO models or functionalities currently used by the UE so as to adapt the AI/ML HO model s/functionalities in case the situation changed, for example in case the UE moved into a location where a different AI/ML HO models is advantageous over the currently used one.

The information about the position of the UE may include one or more of the following:
information about a geographical region or location where the UE is located, e.g.,
   a communication range, like a distance from another entity of the wireless communication network device in terms of a minimum required communication range, MCR,
   a location of the UE, e.g. GPS, GLONASS, BEIDOU, GALILEO,
   information about the PLMN,
   information about the paging area,
   information about the cell, beam,
   information about RAN-based Notification Area, RNA,
   information about an AI zone or area,
information about a scenario in which the UE is employed, e.g.,
   a scenario type, like urban, suburban, rural, indoors, outdoors, or
   a cell type, like macro, micro, pico-cell, non-terrestrial, NTN, or
   a UE density and distribution in the UE's environment.

In accordance with further embodiments, the UE 400 may send assistance information to the source base station gNB1 or to another UE in the network. The assistance information may comprise one or more of the following:
a speed at which the UE travels,
an elevation angle of the UE,
changes in altitude or vertical motion of the UE,
changes in coordinates of a UE position, e.g., changes in GPS or location coordinates to analyze differences in latitude and longitude (please clarify),
a direction of movement of the UE, e.g., an angle and/or an orientation of the UE in relation to a specific reference point or coordinate system,
beamforming information, e.g., a beam shape and/or a beam pattern, a selected beam index, rank information, a preferred-matrix index, a precoder matrix indictor, PMI, a feedback, a potential beam recovery procedure,
statistical information, e.g., a delay spread, an angular spread, a Doppler shift, line of sight, LOS, and/or non-LOS, NLOS, information,
quality information, like channel quality information of channel state information, CSI, e.g., SNR/SINR/RSRP/RSRQ/RSSI, quantized CSI or compressed CSI, e.g., Doppler-delay precoded CSI feedback,
performance measurements, e.g., a throughput, a latency, a packet delay, a packet loss, a packet error rate, a bit error rate, HARQ statistics, e.g., ACK/NACK ratios, or a number of NACK-only feedback,
a base station IDs, e.g., cell IDs that a UE may decode, e.g., by decoding system information blocks, SIBs, or the top-m or m strongest BS IDs from a plurality of BD IDs,
AI/ML-related information, e.g., a prediction of any of the above-mentioned information, transmitted as a value, a vector, or a bitmap,
AI/ML model ID and/or functionality ID,
a prediction of a next possible BS to perform a handover to, e.g., top-m or m best BS candidates for a conditional handover, CHO,
a compressed neural net, e.g., a pre-trained neural net containing a mobility model of the UE and parameters defining the neural net.

In accordance with embodiments, the UE 400 sends the assistance information responsive to one or more conditions being met. The one or more conditions may include one or more of the following:
a speed of the UE has changed, e.g., the speed reached of dropped below a certain threshold,
a type of the UE related to speed has changed, e.g. a person carrying the UE is no longer with in a vehicle but is now a pedestrian or uses a bicycler,
a change in motion exceeds a configured or preconfigured threshold, e.g., a change in elevation angle, altitude or vertical motion, or in GPS coordinates,
a signal strength of a radio signal, e.g. SNR/SINR/RSRP/RSRQ/RSSI drops below a configured or preconfigured threshold or drops during a predefined time period by more than a configured or preconfigured amount,
a number of unsuccessful data transmissions from the UE to the one or more entities exceeds a configured or preconfigured threshold, e.g., a number of Hybrid automatic repeat request non-acknowledgements, HARQ-NACKs,
an interference level detected on the communication link exceeds a configured or preconfigured threshold,
the UE is in a certain location/area,
the UE is communicating on a certain frequency band, e.g. FR2 or FR3,
a number of Radio Link Failures, RLFs, or of Beam Link Failures, BLFs, exceeds a configured or preconfigured threshold,
one or more CHO conditions have not been fulfilled for a predefined time after a CHO command has been sent,
the UE is performing a HO, a CHO or a LTM-HO to a different cell, e.g., in case of a CHO assistance information may be included when a UE registers at the new cell, e.g., before or after successful connection establishment at the new cell,
the UE receives certain beam-related information, e.g., detects a new beam index, e.g., a better beam to be used.

In accordance with embodiments, the UE 400 may signal the assistance information responsive to receiving a request for such information from the source base station or from any other base station or from the other UE.

In accordance with embodiments, the UE may be a high mobility UE and may indicate its speed to the source base station or to another UE. The UE may estimate its speed on its own, for example based on one or more of the following:
network measurements, e.g. a Doppler shift, a time-of-flight, ToF, measurement, a RSSI, a triangulation based on cell IDs or based on UE IDs measured within its vicinity,
internal methods, e.g. using GPS unit for detecting changes in location over time, or using an accelerometer and/or gyroscope for detecting changes in motion and orientation,
data received from the core network, CN, e.g., from the LMF,
beams, e.g., based on reference signals received from a MIMO or distributed MIMO system, e.g., from a multi-TRP and phase correlations calculated from the one or more co-locate or distributed multi-TRPs,
using a sidelink positioning framework.

In accordance with embodiments, a plurality of different speed ranges may be represented by an associated speed type. The respective types may be related to their speed. In accordance with embodiments, the following types may be defined:
Type A: pedestrian, e.g., 3-5 km/h
Type B: cyclist, e.g., 10-25 km/h
Type C: e-biker, e.g., 16-33 km/h
Type D: car, e.g., 34-50 km/h.

The UE may indicate the speed type to the network which allows improving an accuracy of a handover prediction with a reduces signaling overhead as it is not necessary to continuously provide the actual speed of the UE. The speed type may be signaled responsive to a request from the network and/or after experiencing a certain change of the UE speed. For example, when a person leaves a car the UE may inform about the change of its mobility class when reporting assistance information. Also when moving from outdoor to indoor or vice versa, or when moving into a tunnel or street canyon a UE may report this to the network side.

In conventional handover procedures, before any CHO execution condition is satisfied, upon reception of an HO basic command, a UE executes the HO procedure regardless of any previously received CHO configuration. In other words, the legacy HO configuration takes precedence over the CHO configuration. In a similar way, in accordance with embodiments of the present invention, a precedence of the AI/ML HO model or functionality may be as follows:
The use of the AI/ML HO model or functionality takes precedence over a conventional HO process.
The use of the AI/ML HO model or functionality takes precedence over a conventional CHO process.
The use of the AI/ML HO model or functionality causing the UE to initiate the handover responsive to one or more of the AI/ML metrics being met takes precedence over use of the AI/ML HO model or functionality causing the UE to initiate the handover responsive to receiving from the source base station a signaling indicating one target cell.

Further embodiments of the present invention provide a base station which is capable to handle a handover procedure using AI/ML for selecting one or more suitable target cells for a UE handover. FIG. 5 illustrates the base station gNB1 which may be a base station in accordance with embodiments of the present invention. The base station gNB1 may be referred to as a source base station of the source cell 402 and serves the user device, UE, 400 as is illustrated at 404. The UE 400 is located in the source cell 402 and is configured or preconfigured to be handed over from the source cell 402 to the target cell 406. As is schematically illustrated in FIG. 5, the base station gNB1 includes a signal processing unit 430 allowing the base station gNB1 to use at least one AI/ML-HO model or at least one AI/ML-HO functionality, as is indicated at 432. The base station gNB1 uses the AI/ML-HO model or functionality 432 for selecting one or more target cells suitable for a handover of the UE 400 and/or for determining a suitability of one or more target cells for a handover of the UE, as is illustrated at 434.

In accordance with embodiments, the base station gNB1 receives from the UE 400 a request, for example over the Uu interface 404 and performs the selection of the target cells using the AI/ML-HO model or functionality only responsive to such a request. In accordance with other embodiments, the request may also be received at the base station gNB1 from a further base station, for example from the base station gNB2. This request may be received over a backhaul connection between the base stations gNB1 and gNB2.

Similar as in conventional approaches, the source base station gNB1 may provide the target cells and the conditions for a handover to the UE, or it may provide only the target cells for a potential handover to the UE 400. For example, the base station gNB1 may signal to the UE a handover command for initiating a handover of the UE. The handover command may be signaled over the Uu interface 404 and indicate one or more of the target cells which the base station gNB1 selected from the set and/or determined to be suitable for the handover. In case of a CHO the handover command may include one or more conditions so that the UE 400 may carry out the handover as in the above-described conventional approach once the one or more conditions are met.

In accordance with other embodiments, the source base station gNB1 may only signal to the UE 400 the one or more target cells suitable for the handover for allowing the UE 400 to perform the handover on its own, i.e., to select the target cell to which the UE is to be handed over and determine when the handover is to be carried out.

In accordance with embodiments, the one or more conditions may indicate that the handover is to be carried out within a certain time frame which, for example, may be determined by the timeout of a timer. For example, the AI/ML-HO model or functionality may have determined that the target cells included in the signaling to the UE are valid for a certain period of time so that only within that time frame a reliable handover may be carried out.

In accordance with other embodiments, rather than including a condition into the handover command, the base station may simply send the handover command including, for example, one target cell considered to be most suitable by the base station and, responsive to the handover command, the UE 400 performs the handover the signaled target cell, like in a conventional basic HO procedure.

Stated differently, in accordance with embodiments, the UE 400 may be configured with a plurality of HO target cells which may be considered for a future HO by the source base station gNB1. The configurations each may include basic parameters regarding the potential target cells and after having prepared the UE 400 with multiple potential target cells, the source base station gNB1 may issue a handover command, HO command, to the UE 400 indicating to which cell the UE 400 is to switch to. As described above, the source base station gNB1 uses an AI/ML-HO model or functionality for selecting one or more target cells for a potential handover of the UE 400. The inventive approach is advantageous as it reduces the signaling overhead of sending RRC reconfigurations/conditions of the target cells to the UE 400. For example, as mentioned above, the source base station gNB1 may provide the one or more target cells for allowing the UE 400 to operate in accordance with a basic HO procedure as described above, in accordance with a conventional HO procedure as described above, or in accordance with a LTM-HO procedure.

In accordance with embodiments, the AI/ML-HO model or functionality 432 of the source base station gNB1 may receive as an input measurement data and/or non-measurement data. The measurement data may be obtained from the UE 400 and/or from one or more other network entities of the network, for example from the further base station gNB2 illustrated in FIG. 5 or from other UEs in the surroundings of the UE 400, which are not illustrated in FIG. 5. The non-measurement data may be obtained also from the UE 400 and/or from one or more of the above-mentioned network entities. The AI/ML-HO model or functionality selects the one or more target cells suitable for the handover using the measurement data and/or the non-measurement data.

In accordance with embodiments, the measurement data may comprise one or more of the following:
radio resource measurements, e.g.,
   a reference signal received power, RSRP, measurement, or
   a reference signal received quality, RSRQ, measurement, or
   signal to noise and interference ratio, SINR, measurement,
performance measurements in the uplink and/or in the downlink, e.g.,
   throughput measurements, or
   latency measurements, or
   packet delay measurements, like a propagation delay, a queueing delay or an access delay, or
   packet loss measurements, or
   resource utilization measurements, or
   jitter measurements,
mobility measurements, e.g.,
   a number of handovers, or
   a number of inter- or intra-gNB handovers, or
   a Doppler spread of a received signal, or
   an angular spread of a received signal,
measurements of one or more channel conditions of a radio channel between the UE and a radio access network, RAN, of the wireless communication network, e.g.,
   a line-of-sight, LOS, or non-LOS, NLOS, or
   one or more interference levels or reception levels, like a reference signal received power, RSRP, or a reference signal received quality, RSRQ, or a radio signal strength indicator, RSSI, or a signal to interference plus noise ratio, SINR, or a signal to noise ratio SNR, or
   one or more CQI and CSI measurements, or
   a pathloss.

The non-measurement data may comprise one or more of the following:
information about a communication condition of the UE,
assistance information received from the UE and/or from one or more other network entities of the wireless communication network, like another UE or another base station or the core network, CN,
information about a position of the UE,
data on one or more earlier handover processes.

The above-mentioned assistance information may comprise one or more of the following:
a speed at which the UE travels,
an elevation angle of the UE,
changes in altitude or vertical motion of the UE,
changes in coordinates of a UE position, e.g., changes in GPS or location coordinates to analyze differences in latitude and longitude (please clarify),
a direction of movement of the UE, e.g., an angle and/or an orientation of the UE in relation to a specific reference point or coordinate system,
beamforming information, e.g., a beam shape and/or a beam pattern, a selected beam index, rank information, a preferred-matrix index, a precoder matrix indictor, PMI, a feedback, a potential beam recovery procedure,
statistical information, e.g., a delay spread, an angular spread, a Doppler shift, line of sight, LOS, and/or non-LOS, NLOS, information,
quality information, like channel quality information of channel state information, CSI, e.g., SNR/SINR/RSRP/RSRQ/RSSI, quantized CSI or compressed CSI, e.g., Doppler-delay precoded CSI feedback,
performance measurements, e.g., a throughput, a latency, a packet delay, a packet loss, a packet error rate, a bit error rate, HARQ statistics, e.g., ACK/NACK ratios, or a number of NACK-only feedback,
a base station IDs, e.g., cell IDs that a UE may decode, e.g., by decoding system information blocks, SIBs, or the top-m or m strongest BS IDs from a plurality of BD IDs,
AI/ML-related information, e.g., a prediction of any of the above-mentioned information, transmitted as a value, a vector, or a bitmap,
a prediction of a next possible BS to perform a handover to, e.g., top-m or m best BS candidates for a conditional handover, CHO,
a compressed neural net, e.g., a pre-trained neural net containing a mobility model of the UE and parameters defining the neural net.

In accordance with further embodiments, the source base station gNB1 may train its AI/ML-HO model or functionality using the above-mentioned assistance information. For example, the assistance information may be used for AI/ML training/interference for one or more of the following:
enhancing one or more of the following: a handover, HO, prediction, a conditional handover, CHO, prediction, a L1/L2 Triggered Mobility, LTM, handover prediction,
enhancing candidate prediction in HO, CHO and LTM,
enhancing beam prediction in HO, CHO and LTM,
tuning of one or more HO parameters, e.g., tuning of a hysteresis margin or an HO margin used to avoid ping-pong effects,
enhancing a prediction of a HO in a NR-Unlicensed Spectrum, e.g. by improving an accuracy of a Listen-Before-Talk, LBT, result,
enhancing a prediction of a HO in a Non-Terrestrial Network, NTN, including, e.g., high altitude platforms, HAPs, in which both UE and NW operate in motion,
enhancing a Finite Impulse Response, FIR, filtering of L1 measurements,
enhancing an Infinite Impulse Response, IIR, filtering of L3 measurements,
enhancing HO failure prediction,
enhancing Radio Link Failure, RLF prediction,
enhancing measurement events prediction.

In accordance with embodiments, the source base station gNB1 may receive the assistance information from the UE 400 or another UE or another base station or the core network, CN, only in case one or more predefined conditions are met. The predefined conditions may comprise one or more of the following:
a speed of the UE has changed, e.g., the speed reached of dropped below a certain threshold,
a type of the UE related to speed has changed, e.g. a person carrying the UE is no longer with in a vehicle but is now a pedestrian or uses a bicycler,
a change in motion exceeds a configured or preconfigured threshold, e.g., a change in elevation angle, altitude or vertical motion, or in GPS coordinates,
a signal strength of a radio signal, e.g. SNR/SINR/RSRP/RSRQ/RSSI drops below a configured or preconfigured threshold or drops during a predefined time period by more than a configured or preconfigured amount,
a number of unsuccessful data transmissions from the UE to the one or more entities exceeds a configured or preconfigured threshold, e.g., a number of Hybrid automatic repeat request non-acknowledgements, HARQ-NACKs,
an interference level detected on the communication link exceeds a configured or preconfigured threshold,
the UE is in a certain location/area,
the UE is communicating on a certain frequency band, e.g. FR2 or FR3,
a number of Radio Link Failures, RLFs, or of Beam Link Failures, BLFs, exceeds a configured or preconfigured threshold,
one or more CHO conditions have not been fulfilled for a predefined time after a CHO command has been sent,
the UE is performing a HO, a CHO or a LTM-HO to a different cell, e.g., in case of a CHO assistance information may be included when a UE registers at the new cell, e.g., before or after successful connection establishment at the new cell.

In accordance with further embodiments, the source base station gNB1 may request from the UE 400 the assistance information, for example, based on one or more of the following:
a timer, e.g.,
   when the assistance information available at the BS is outdated or has a certain age, or
   at regular timer intervals,
an event, e.g.,
   when the UE transmits a HO request to the network, or
   when the UE moves into a certain area or location,
previous assistance information, e.g.,
   when the UE reports a change in location, or
   on the current CSI, like in case of a sudden higher pathloss causing the BS to assume that the UE has moved indoors; for example, when receiving the CSI values with a sudden degradation, the BS might be triggered to send a request to UE, asking for more detailed assistance data, e.g. LoS, etc.

In accordance with further embodiments of the present invention, the above-mentioned information about the communication condition may comprise one or more of the following:
information about a configuration of a site at which the UE is located, e.g.,
   a bandwidth or bandwidth part used for the communication, or
   a carrier frequency or carrier selection in case of scenarios involving carrier aggregation, CA, or
   a carrier configuration or bandwidth part configuration, e.g., a numerology for OFDM, or
   an antenna configuration, e.g., a number of antennas, an antenna setting, like MIMO, or
   modulation and coding scheme, MCS, information, or
   a gNB beam codebook, or
   a gNB virtualization configuration, or
   a transmission power,
information about beamforming performed at the UE and/or at a UE's communication partner, e.g.,
   a beam direction, or
   codebook information,
information about quality of service, QoS, conditions,
information about a cell load and/or a cell congestion of the source and/or target cells.

The information about the position of the UE 400 may comprise one or more of the following:
information about a geographical region or location where the UE is located, e.g.,
   a communication range, like a distance from another entity of the wireless communication network device in terms of a minimum required communication range, MCR,
   a location of the UE, e.g. GPS, GLONASS, BEIDOU, GALILEO,
   information about the PLMN,
   information about the paging area,
   information about the cell, beam,
   information about RAN-based Notification Area, RNA,
   information about an AI zone or area,
information about a scenario in which the UE is employed, e.g.,
   a scenario type, like urban, suburban, rural, indoors, outdoors, or
   a cell type, like macro, micro, pico-cell, or
   a UE density and distribution in the UE's environment.

In accordance with embodiments, the above-mentioned data on or more earlier handover processes may comprise one or more of the following:
information from prior handover processes performed in a specific area,
information from prior handover processes performed in a specific time slot,
information from one or more neighboring cells involved in a HO process, e.g., a cell ID,
information on a ratio of HO success/failure when executing a HO,
information on conditions or thresholds that triggered handovers, e.g., timers, measurements
information on previous ping-pong effects, e.g., the UE frequently switched between two cells,
information on the duration for which a UE was attached to the base station and/or neighboring cells.

Thus, by using data on one or more earlier handover processes, the source base station or gNB employs a proactive approach to the handover by gathering and storing information from prior handover processes, such as specific areas and timeslots. This data may be used to predict optimal initiation times and locations for a handover, mitigating the risk of failure and enhancing efficiency. This mechanism effectively minimizes service interruptions and reduces the necessity for frequent measurements and associated overhead. The performance of this probabilistic-based proactive AI/ML based handover may depend on certain parameters, for example on a number of collected samples, and observation time, a dynamic of a network topology. The performance of this approach may be improved by increasing both the quantity and variety of the samples taken.

In accordance with further embodiments, the base station gNB1 may prioritize one or more of the target cells suitable for the handover of the UE 400. In accordance with embodiments, the source base station gNB1 may prioritize those target cells that have a potential to minimize an energy consumption of the UE 400, thereby implementing an energy saving HO. In accordance with other embodiments, the source base station gNB1 may prioritize target cells that align with the traffic requirements of the UE for ensuring, for example, a seamless user experience, thereby implementing a throughput HO. In accordance with yet other embodiments, the source base station gNB1 may prioritize target cells that are capable of meeting specific QoS and/or latency requirements, for example for addressing the need of the UE for a reliable and low-latency communication, thereby implementing latency/QoS HO.

In accordance with further embodiments, the source base station gNB1 may provide a beam ID and/or a beam configuration for a selected target cell to the UE 400 thereby reducing an access time for the UE as it is not required by the UE 400 to perform a beam initialization procedure. For example, the UE 400 may measure multiple beams of neighboring or candidate target cells and report L3 measurement results to the source base station gNB1. The source base station gNB1 may use this information to determine a beam for the respective target cells. The source base station gNB1 may provide multiple potential beams and/or beam configurations for the one or more target cells. The multiple beams may be associated with a certain area, and/or with a UE direction and/or with a UE speed.

In accordance with embodiments, in the base station gnB1 one or more of the following may apply:
AI/ML HO and/or AIML CHO takes precedence over a conventional HO process.
A conventional HO process takes precedence over AI/ML HO and/or AI/ML CHO.
AI/ML HO and/or AIML CHO takes precedence over a conventional CHO process.
AI/ML HO and/or AIML CHO causing the UE to initiate the handover responsive to one or more AI/ML metrics being met takes precedence over use of AI/ML HO and/or AIML CHO causing the UE to initiate the handover responsive to receiving from the BS a signaling indicating a target cell.

### General

Embodiments of the present invention have been described in detail above, and the respective embodiments and aspects may be implemented individually or two or more of the embodiments or aspects may be implemented in combination.

Embodiments of the present invention have been described with reference to a source cell and a target cell, like the cells 402, 406 illustrated in FIG. 5. In accordance with embodiments, the target cell and/or source cell may be a cell, for example a sector of a gNB or the entire coverage of a gNB as illustrated in FIG. 5, a Pcell a or Scell. However, the present invention is not limited to such embodiment, rather, in accordance with other embodiments, the target cell may be one or more of the following:
a beam,
a transmission/reception point, TRP, e.g., a multi-TRP like a co-located or distributed multi-TRP,
a cell, e.g., a sector of a base station or gNB, or a Primary Cell, PCell, or a Secondary Cell, SCell,
a base station or gNB,
a relay node,
an Integrated Access and Backhaul, IAB, node,
a UE, e.g., in case a UE moves out of coverage of base station, it may connect via sidelink PC5 to another UE.

Thus, a UE, like UE 400 in FIG. 5, may operate on a certain beam, for example in case a base station performs beamforming. In such a scenario, the handover may be within the same cell but to a different beam provided by the base station which might offer better communication conditions. In that case, the source cell is a source beam of a base station currently used for a communication with the UE, and the UE is handed over to a target beam of the same base station or a different base station, for example, for improving the communication conditions. In accordance with other embodiments, the handover may be from one entity type to another entity type, for example the UE 400 may be served by a beam from a base station and may be handed over to any of the other entities, for example to another base station not providing beam forming or to another UE.

In accordance with embodiments, the wireless communication system may include a terrestrial network, or a non-terrestrial network, or networks or segments of networks using as a receiver an airborne vehicle or a space-borne vehicle, or a combination thereof. Further, the wireless communication system may by a system or network different from the above described 4G or 5G mobile communication systems, rather, embodiments of the inventive approach may also be implemented in any other wireless communication network, e.g., in a private network, such as an Intranet or any other type of campus networks, or in a WiFi communication system.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, like a station (STA), access point (AP), node or mesh node, or mesh point, or Mesh AP, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a Wi-Fi device such as an access point (AP) or mesh node (Mesh AP), or a remote radio head, or an AMF, or a MME, or a SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear, that these aspects also represent a description of the corresponding method, where a block or a device corresponds to a method step or a feature of a method step. Analogously, aspects described in the context of a method step also represent a description of a corresponding block or item or feature of a corresponding apparatus.

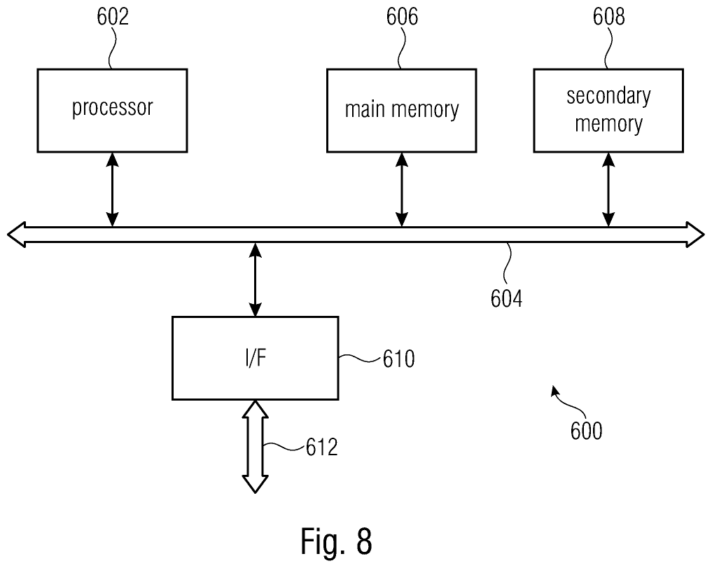

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are advantageously performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

What is claimed:

1. A user device, UE, for a wireless communication network, wherein the UE is configured or preconfigured to be handed over from the source cell of the wireless communication network to a target cell of the wireless communication network, and
wherein the UE is to use at least one Artificial Intelligence/Machine Learning, AI/ML, handover, HO, model or at least one AI/ML HO functionality for performing one or more of the following:
selecting from a set of target cells one or more target cells suitable for a handover,
determining a suitability of one or more target cells for a handover.

2. The user device, UE, of claim 1, wherein the UE is configured or preconfigured with the set of target cells, e.g., receives the set of target cells from a source base station of the source cell.

3. The user device, UE, of claim 1, wherein the UE is configured or preconfigured with one or more minimum conditions for triggering the handover, and wherein the set of target cells comprises a plurality of target cells fulfilling the one or more minimum conditions.

4. The user device, UE, of claim 1, wherein the minimum conditions comprise one or more of the following:
a power threshold, e.g., CQI, RSRP, RSRQ, SINR, SNR,
a hysteresis offset,
a distance to the associated target cell, e.g., 2D-distance, 3D-distance,
a threshold on the interference level,
a gNB configuration, e.g., beam codebook, rural, urban, antenna configuration,
a gNB location or area, e.g., the UE may be barred from accessing certain gNBs that are in a specific area,
a performance threshold for the current cell or cell group, e.g., a throughput threshold, a delay threshold, a HARQ threshold (number or ratio of ACKs or NACKs in a certain time window for one or more cells),
a threshold on past performance values or statistics, e.g., related to Radio Link Failure, RLF, Beam Link Failure, BLF, Handover Failure, HOF in the past, e.g., in a certain time window, ping-pong effects,
a beam threshold and/or minimum suitable beam number, e.g., a certain number of beams have to be above a certain power level,
a threshold on the battery level, e.g., UE should access a cell only if the battery drops below certain level or is above a certain level,
a supported QoS, e.g., the target may only support
a certain duration for the which the minimum conditions have to be fulfilled before a UE considers a handover,
a certain duration for which the UE must stay in the current cell or cell group.

5. The user device, UE, of claim 1, wherein the AI/ML HO model or functionality provides for one or more target cells one or more AI/ML metrics, and
wherein the UE is to initiate the handover to one of the one or more target cells only when one or more of the AI/ML metrics associated to the said target cell, which are provided by the AI/ML HO model or functionality, are larger or smaller than a configured or preconfigured threshold or than the AI/ML metric for the current cell.

6. The user device, UE, of claim 1, wherein the AI/ML HO model or functionality provides for one or more target cells one or more AI/ML metrics, and
wherein the UE is to signal the one or more AI/ML metrics to the source base station.

7. The user device, UE, of claim 1, wherein the signal comprises a handover request in addition to the AI/ML metric.

8. The user device, UE, of claim 1, wherein the UE is to
send the selected one or more target cells to a source base station of the source cell, and
receive from the source base station a signaling indicating one target cell, and
initiate the handover to the target cell indicated in the signaling from the source base station, or authorize the UE to perform a handover or conditional handover to the indicated target cell immediately or later or within a certain time duration.

9. The user device, UE, of claim 1, wherein, in case of a timeout or in case the UE does not receive the signaling from the source base station, e.g., due to radio link failure to the source base station, the UE is to
initiate the handover to a primary target cell, e.g., listed as top-1 in a list of target cells previously send to a source base station of the source cell, or
perform a handover to a configured or preconfigured or default target cell, e.g., a target cell operating in a lower frequency range or a target cell comprising a larger coverage area, e.g., a NTN-cell, or
refrain from performing a handover, or
switch to RRC_INACTIVE or RRC_IDLE or RRC_AI_NON_CONNECTED.

10. The user device, UE, of claim 1, wherein the UE is configured or preconfigured with a handover configuration, wherein the handover configuration comprises for each of the target cells
the one or more AI/ML metric configurations, e.g., that the AI/ML metric is a handover probability or a confidence level or a handover failure probability or a handover failure confidence level or a RLF probability or a RLF confidence level, and
for each of the one or more AI/ML metrics a definition when the AI/ML metric triggers a handover or makes the target cell suitable for handover, e.g., an AI/ML handover probability threshold to be exceeded for a handover to be triggered or the target cell to be considered by another AI as a potential target cell candidate.

11. The user device, UE, of claim 1, wherein a plurality of the AI/ML HO models or functionalities are provided, and wherein
the UE is configured or preconfigured with the plurality of the AI/ML HO models or functionalities, and is to determine one or more of the plurality of AI/ML HO models or functionalities to be used by the UE responsive to
receiving from the source base station a signaling that specifies the one or more AI/ML HO models or functionalities to be used by the UE, e.g., an AI/ML HO model or functionality ID, and/or
information about a position of the UE e.g., by selecting one or more AI/ML HO models or functionalities associated with a cell ID, a zone and/or paging area, and/or
the UE is to receive from the source base station
one or more of the plurality of AI/ML HO models or functionalities to be used by the UE, and/or
an update, like updated parameters, for one or more AI/ML HO models or functionalities currently used by the UE.

12. The user device, UE, of claim 1, wherein the UE is to send to the source base station or to another UE assistance information; and/or
wherein the assistance information comprises one or more of the following:
a speed at which the UE travels,
an elevation angle of the UE,
changes in altitude or vertical motion of the UE,
changes in coordinates of a UE position, e.g., changes in GPS or location coordinates to analyze differences in latitude and longitude (please clarify),
a direction of movement of the UE, e.g., an angle and/or an orientation of the UE in relation to a specific reference point or coordinate system,
beamforming information, e.g., a beam shape and/or a beam pattern, a selected beam index, rank information, a preferred-matrix index, a precoder matrix indictor, PMI, a feedback, a potential beam recovery procedure,
statistical information, e.g., a delay spread, an angular spread, a Doppler shift, line of sight, LOS, and/or non-LOS, NLOS, information,
quality information, like channel quality information of channel state information, CSI, e.g., SNR/SINR/RSRP/RSRQ/RSSI, quantized CSI or compressed CSI, e.g., Doppler-delay precoded CSI feedback,
performance measurements, e.g., a throughput, a latency, a packet delay, a packet loss, a packet error rate, a bit error rate, HARQ statistics, e.g., ACK/NACK ratios, or a number of NACK-only feedback,
a base station IDs, e.g., cell IDs that a UE may decode, e.g., by decoding system information blocks, SIBs, or the top-m or m strongest BS IDs from a plurality of BD IDs,
AI/ML-related information, e.g., a prediction of any of the above-mentioned information, transmitted as a value, a vector, or a bitmap,
AI/ML model ID and/or functionality ID,
a prediction of a next possible BS to perform a handover to, e.g., top-m or m best BS candidates for a conditional handover, CHO,
a compressed neural net, e.g., a pre-trained neural net comprising a mobility model of the UE and parameters defining the neural net.

13. A base station, BS, for a wireless communication network,
wherein the BS is a source base station of a source cell and serves a user device, UE, of the wireless communication network, located in the source cell, UE being configured or preconfigured to be handed over from the source cell to a target cell of the wireless communication network, and
wherein the BS is to use at least one Artificial Intelligence/Machine Learning model, AI/ML, handover, HO, model or at least one AI/ML HO functionality for performing one or more of the following:
selecting one or more target cells suitable for a handover of the UE,
determining a suitability of one or more target cells for a handover of the UE.

14. The base station, BS, of claim 13, wherein an input of the AI/ML HO model or functionality comprises
measurement data acquired from the UE and/or from one or more other network entities of the wireless communication network, and/or
non-measurement data acquired from the UE and/or from one or more other network entities of the wireless communication network, and
wherein the AI/ML HO model or functionality is to select the one or more target cells suitable for the handover using the measurement data and/or the non-measurement data.

15. The base station, BS, of claim 13, wherein the non-measurement data comprise one or more of the following:
information about a communication condition of the UE,
assistance information received from the UE and/or from one or more other network entities of the wireless communication network,
information about a position of the UE,
data on one or more earlier handover processes; and/or
wherein the BS is to train the AI/ML HO model or functionality using the assistance information.

16. The base station, BS, of claim 13, wherein the BS is to
use the AI/ML HO model or functionality for predicting for one or more of the target cells suitable for the handover a beam ID and/or a beam configuration, and/or
provide the beam ID and/or the beam configuration to the UE, e.g., by including the beam ID and/or the beam configuration into the handover command.

17. A wireless communication network, like a 3^{rd} Generation Partnership Project, 3GPP, system, comprising a one or more user devices, UEs, of claim 1 and/or one or more base stations, BSs, for a wireless communication network,
wherein the BS is a source base station of a source cell and serves a user device, UE, of the wireless communication network, located in the source cell, UE being configured or preconfigured to be handed over from the source cell to a target cell of the wireless communication network, and
wherein the BS is to use at least one Artificial Intelligence/Machine Learning model, AI/ML, handover, HO, model or at least one AI/ML HO functionality for performing one or more of the following:
selecting one or more target cells suitable for a handover of the UE, and
determining a suitability of one or more target cells for a handover of the UE.

18. A method for operating a user device, UE, for a wireless communication network, wherein the UE is configured or preconfigured to be handed over from the source cell of the wireless communication network to a target cell of the wireless communication network, the method comprising:
using, by the UE, at least one Artificial Intelligence/Machine Learning, AI/ML, handover, HO, model or at least one AI/ML HO functionality for performing one or more of the following:
selecting from a set of target cells one or more target cells suitable for a handover,
determining a suitability of one or more target cells for a handover.

19. A method for operating a user device, UE, for a wireless communication network, wherein the BS is a source base station of a source cell and serves a user device, UE, of the wireless communication network, located in the source cell, UE being configured or preconfigured to be handed over from the source cell to a target cell of the wireless communication network, the method comprising:
using, by the BS, at least one Artificial Intelligence/Machine Learning model, AI/ML, handover, HO, model or at least one AI/ML HO functionality for performing one or more of the following:
selecting one or more target cells suitable for a handover of the UE, and
determining a suitability of one or more target cells for a handover of the UE.

20. A non-transitory digital storage medium having a computer program stored thereon to perform the method of claim 18 when said computer program is run by a computer.
